(19) United States
(12) Patent Application Publication
(10) Pub. No.: US 2025/0168706 A1
(43) Pub. Date: May 22, 2025

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/033,138

(22) Filed: Jan. 21, 2025

Related U.S. Application Data
(63) Continuation of application No. PCT/JP2023/026843, filed on Jul. 21, 2023.

(30) Foreign Application Priority Data
Jul. 22, 2022 (JP) 2022-117532

(51) Int. Cl. H04W 28/18; H04L 5/00; H04L 41/16; H04W 72/23

(52) U.S. Cl. CPC H04W 28/18; H04L 5/0048; H04L 41/16; H04W 72/23

(57) ABSTRACT

A communication method for applying a machine learning technology to wireless communication between a user equipment and a network node in a mobile communication system includes: transmitting, by one communication apparatus among a user equipment and a network node, a notification indicating at least one selected from the group consisting of including an untrained model, including a model in training, and including a trained model on which testing has been completed to the other communication apparatus among the user equipment and the network node; and receiving, by the one communication apparatus, a response corresponding to the notification from the other communication apparatus.

### RELATED APPLICATIONS

The present application is a continuation based on PCT Application No. PCT/JP2023/026843, filed on Jul. 21, 2023, which claims the benefit of Japanese Patent Application No. 2022-117532 filed on Jul. 22, 2022. The content of which is incorporated by reference herein in their entirety.

### TECHNICAL FIELD

The present disclosure relates to a communication method used in a mobile communication system.

### BACKGROUND

In recent years, in the Third Generation Partnership Project (3GPP) (trade name, the same shall apply hereinafter), which is a standardization project for mobile communication systems, a study is underway to apply an artificial intelligence (AI) technology, particularly, a machine learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In a first aspect, a communication method is a method for applying a machine learning technology to wireless communication between a user equipment and a base station in a mobile communication system. The communication method includes: transmitting, by one communication apparatus among a user equipment and a base station, a notification indicating at least one selected from the group consisting of including an untrained model, including a model in training, and including a trained model on which testing has been completed to the other communication apparatus among the user equipment and the base station; and receiving, by the one communication apparatus, a response corresponding to the notification from the other communication apparatus.

In a second aspect, a communication method is a method for applying a machine learning technology to wireless communication between a user equipment and a base station in a mobile communication system. The communication method includes: performing, by one communication apparatus among a user equipment and a base station, inference processing using a trained model obtained by training a model; determining, by the one communication apparatus, necessity of retraining the model by monitoring a performance of the trained model; and transmitting, by the one communication apparatus, a notification indicating the necessity of the retraining to the other communication apparatus among the user equipment and the base station, in response to determining that the retraining is necessary.

In a third aspect, a communication method is a method for applying a machine learning technology to wireless communication between a user equipment and a base station in a mobile communication system. The communication method includes: receiving, by one communication apparatus among a user equipment and a base station, configuration information including information indicating a time during which a data set configured to monitor a performance of a trained model is provided from the other communication apparatus among the user equipment and the base station; and receiving, by the one communication apparatus, the data set from the other communication apparatus and performing monitoring processing of monitoring the performance of the trained model using the data set during the time.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of an AI/ML technology (machine learning technology) in the mobile communication system according to an embodiment.

FIG. 7 is a diagram illustrating an overview of operations relating to each operation scenario according to an embodiment.

FIG. 8 is a diagram illustrating a first operation scenario according to an embodiment.

FIG. 9 is a diagram illustrating a first example of reducing CSI-RSs according to an embodiment.

FIG. 10 is a diagram illustrating a second example of reducing the CSI-RSs according to an embodiment.

FIG. 11 is an operation flow diagram illustrating a first operation pattern relating to the first operation scenario according to an embodiment.

FIG. 12 is an operation flow diagram illustrating a second operation pattern relating to the first operation scenario according to an embodiment.

FIG. 13 is an operation flow diagram illustrating a third operation pattern relating to the first operation scenario according to an embodiment.

FIG. 14 is a diagram illustrating a second operation scenario according to an embodiment.

FIG. 15 is an operation flow diagram illustrating an operation example relating to the second operation scenario according to an embodiment.

FIG. 16 is a diagram illustrating a third operation scenario according to an embodiment.

FIG. 17 is an operation flow diagram illustrating an operation example relating to the third operation scenario according to an embodiment.

FIG. 18 is a diagram illustrating a first operation pattern relating to model transfer according to an embodiment.

FIG. 19 is a diagram illustrating an example of a configuration message including models and additional information according to an embodiment.

FIG. 20 is a diagram illustrating a second operation pattern relating to model transfer according to an embodiment.

FIG. 21 is a diagram illustrating a third operation pattern relating to model transfer according to an embodiment.

FIG. 22 is a diagram illustrating an example of model management according to an embodiment.

FIG. 23 is a diagram illustrating details of model management according to an embodiment.

FIG. 24 is a diagram illustrating a first operation pattern relating to model monitoring according to an embodiment.

FIG. 25 is a diagram illustrating an example of applying the AI/ML technology to CSI feedback as an example of a second operation pattern relating to model monitoring according to an embodiment.

FIG. 26 is a diagram illustrating an example of applying the AI/ML technology to positioning as another example of the second operation pattern relating to model monitoring according to an embodiment.

FIG. 27 is a diagram illustrating CSI feedback and beam management to which the AI/ML technology is applied according to an embodiment.

FIG. 28 is a diagram for illustrating beam management to which the AI/ML technology is applied according to an embodiment.

FIG. 29 is a diagram illustrating a specific example of CSI feedback to which the AI/ML technology is applied according to an embodiment.

FIG. 30 is a diagram illustrating a specific example of beam management to which the AI/ML technology is applied according to an embodiment.

### DESCRIPTION OF EMBODIMENTS

For applying a machine learning technology to a mobile communication system, a specific technique for leveraging machine learning processing has not yet been established.

In view of this, the present disclosure is to enable the machine learning processing to be leveraged in the mobile communication system.

A mobile communication system according to an embodiment is described with reference to the drawings. In the description of the drawings, the same or similar parts are denoted by the same or similar reference signs.

### Configuration of Mobile Communication System

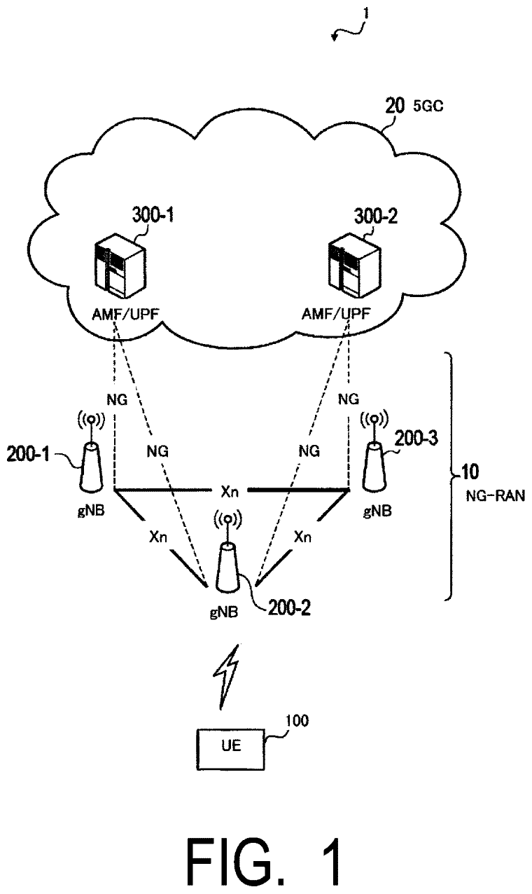

First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

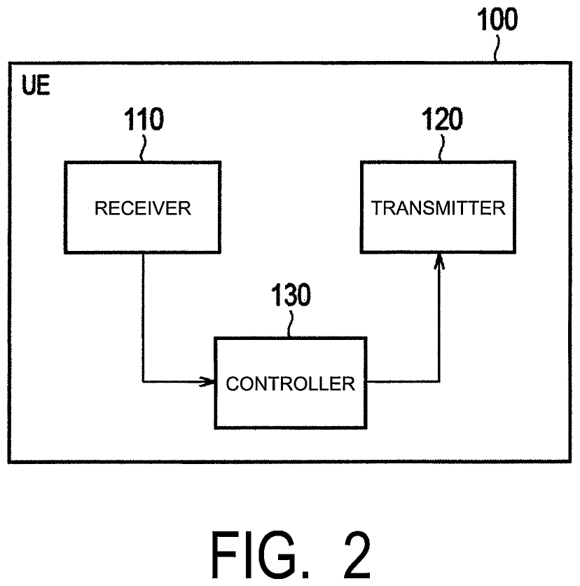

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

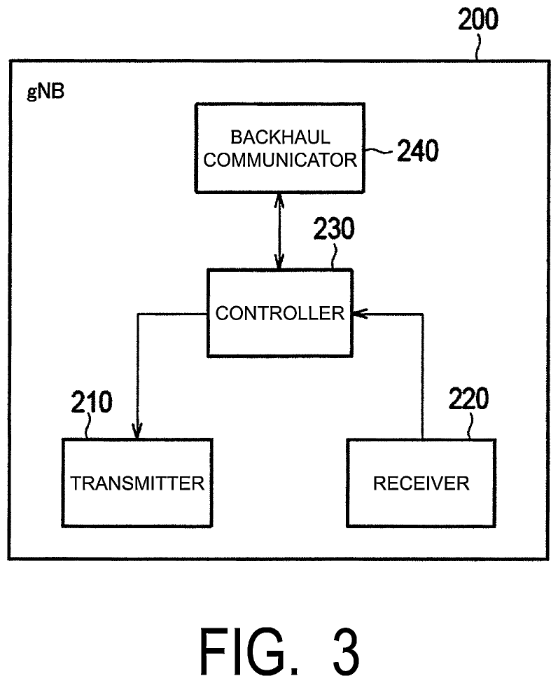

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a central unit (CU) and a distributed unit (DU) (i.e., functions are divided), and the two units may be connected via an F1 interface, which is a fronthaul interface.

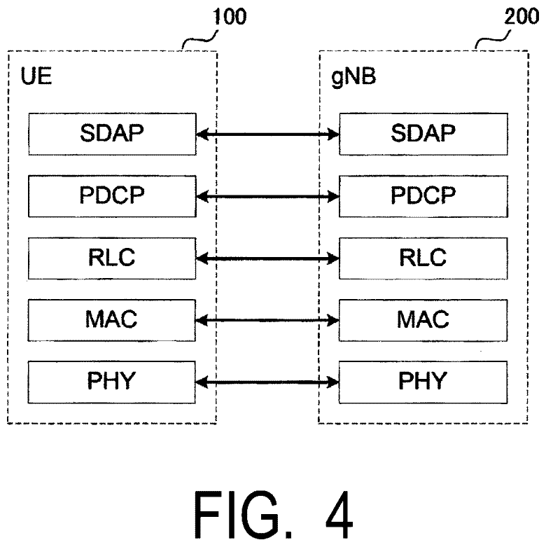

FIG. 4 is a diagram illustrating a configuration of a protocol stack of a radio interface of a user plane handling data.

A radio interface protocol of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

In the NR, the UE 100 may use a bandwidth that is narrower than a system bandwidth (i.e., a bandwidth of the cell). The gNB 200 configures a bandwidth part (BWP) consisting of consecutive physical resource blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by control in the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on the serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an access stratum (AS). Note that, when the RAN is connected to the EPC, the SDAP need not be provided.

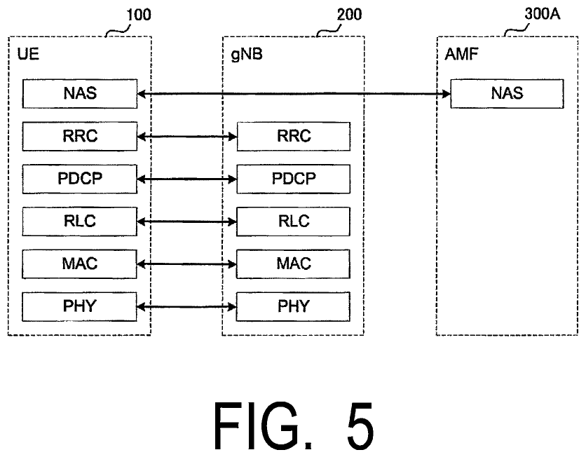

FIG. 5 is a diagram illustrating a configuration of a protocol stack of a radio interface of a control plane handling signaling (a control signal).

The protocol stack of the radio interface of the control plane includes a radio resource control (RRC) layer and a non-access stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of AI/ML Technology

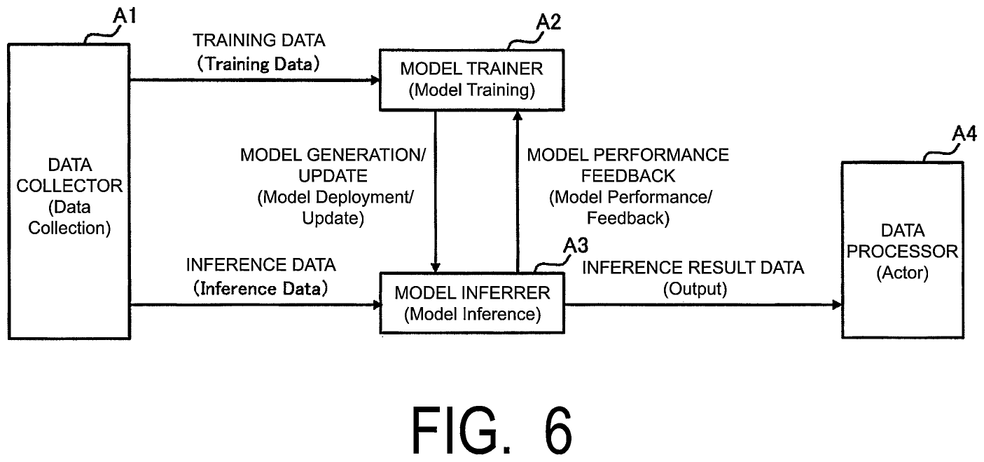

In an embodiment, an AI/ML Technology is described. FIG. 6 is a diagram illustrating a functional block configuration of the AI/ML technology (also referred to as the “machine learning technology”) in the mobile communication system 1 according to an embodiment.

The functional block configuration illustrated in FIG. 6 includes a data collector A1, a model trainer A2, a model inferrer A3, and a data processor A4.

The data collector A1 collects input data, specifically, training data and inference data, and outputs the training data to the model trainer A2 and outputs the inference data to the model inferrer A3. The data collector A1 may acquire, as the input data, data in an apparatus provided with the data collector A1 itself. The data collector A1 may acquire, as the input data, data in another apparatus.

The model trainer A2 performs model training. To be specific, the model trainer A2 optimizes parameters for the training model (hereinafter also referred to as a “model” or an “AI/ML model”) by machine learning using the training data, derives (generates or updates) a trained model, and outputs the trained model to the model inferrer A3. The model is data-driven algorithm in which a set of outputs is generated based on a set of inputs through application of the AI/ML technology. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the training data. The unsupervised learning is a method of not using correct answer data for the training data. For example, in the unsupervised learning, feature points are learned from a large amount of training data, and correct answer determination (range estimation) is performed. The reinforcement learning is a method of assigning a score to an output result and learning a method of maximizing the score.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. Here, various techniques for the model are used, such as linear regression analysis, neural network, and decision tree analysis. The above “y=ax+b” can be considered as a kind of the linear regression analysis. The model inferrer A3 may perform model performance feedback to the model trainer A2.

The data processor A4 receives the inference result data and performs processing using the inference result data.

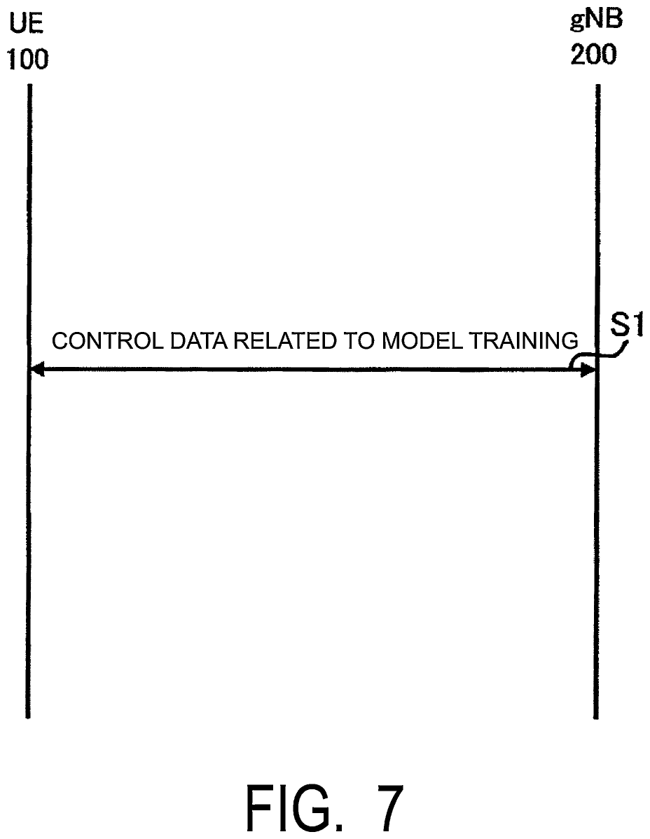

FIG. 7 is a diagram illustrating an overview of operations relating to each operation scenario according to an embodiment. In FIG. 7, one of the UE 100 and the gNB 200 corresponds to a first communication apparatus, and the other corresponds to a second communication apparatus.

In step S1, the UE 100 transmits or receives control data related to the machine learning technology to or from the gNB 200. The control data may be an RRC message that is RRC layer (i.e., layer 3) signaling. The control data may be a MAC Control Element (CE) that is MAC layer (i.e., layer 2) signaling. The control data may be downlink control information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Fist Operation Scenario

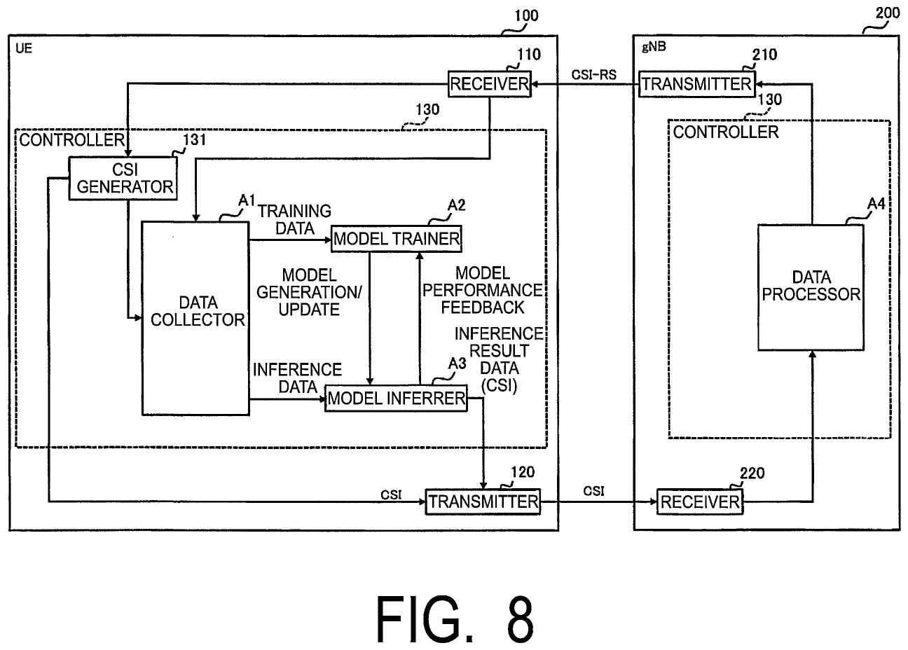

FIG. 8 is a diagram illustrating a first operation scenario according to an embodiment. In the first operation scenario, the data collector A1, the model trainer A2, and the model inferrer A3 are arranged in the UE 100 (e.g., the controller 130), and the data processor A4 is arranged in the gNB 200 (e.g., the controller 230). In other words, model training and model inference are performed on the UE 100 side.

In the first operation scenario, the machine learning technology is introduced into channel state information (CSI) feedback from the UE 100 to the gNB 200. The CSI (CSI feedback information) transmitted (fed back) from the UE 100 to the gNB 200 is information related to a downlink channel state between the UE 100 and the gNB 200. The CSI includes at least one selected from the group consisting of a channel quality indicator (CQI), a precoding matrix indicator (PMI), and a rank indicator (RI). The gNB 200 performs, for example, downlink scheduling based on the CSI feedback from the UE 100.

The gNB 200 transmits a reference signal for the UE 100 to estimate a downlink channel state. Such a reference signal may be, for example, a CSI reference signal (CSI-RS). Such a reference signal may also be a demodulation reference signal (DMRS). For example, it is assumed that the reference signal is a CSI-RS.

First, in the model training, the UE 100 (receiver 110) receives a first reference signal from the gNB 200 by using a first resource. Then, the UE 100 (model trainer A2) derives a trained model for inferring CSI from the reference signal by using training data including the first reference signal. Such a first reference signal may be referred to as a full CSI-RS.

For example, the UE 100 (CSI generator 131) performs channel estimation by using the reception signal (CSI-RS) received by the receiver 110 from the gNB 200, and generates CSI. The UE 100 (transmitter 120) transmits the generated CSI to the gNB 200. The model trainer A2 performs model training by using a plurality of sets of the reception signal (CSI-RS) and the CSI as the training data to derive a trained model for inferring the CSI from the reception signal (CSI-RS).

Second, in the model inference, the UE 100 (receiver 110) receives a second reference signal from the gNB 200 by using a second resource that is less than the first resource. Then, the UE 100 (model inferrer A3) uses the trained model to infer the CSI as the inference result data from inference data including the second reference signal. In the description of the first operation scenario, such a second reference signal may be referred to as a partial CSI-RS or a punctured CSI-RS.

For example, the UE 100 (model inferrer A3) uses the reception signal (CSI-RS) received by the receiver 110 from the gNB 200 as the inference data, and infers the CSI from the reception signal (CSI-RS) by using the trained model. The UE 100 (transmitter 120) transmits the inferred CSI to the gNB 200.

This enables the UE 100 to feed back accurate (complete) CSI to the gNB 200 from a small number of CSI-RSs (partial CSI-RSs) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

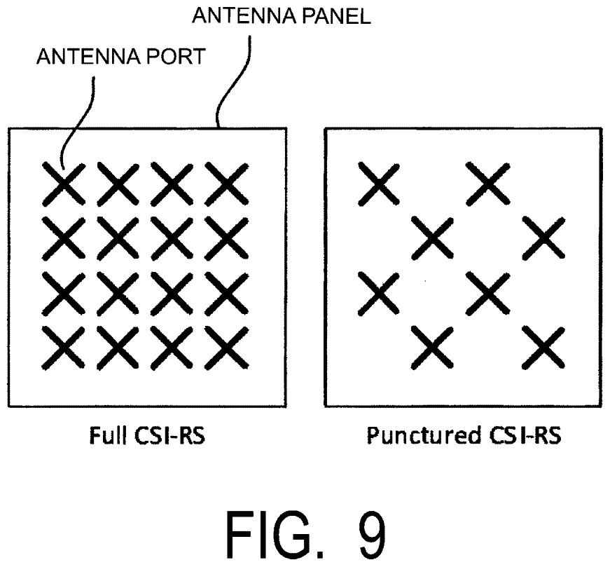

FIG. 9 is a diagram illustrating a first example of reducing CSI-RSs according to an embodiment. In the first example, the gNB 200 reduces the number of antenna ports for transmitting the CSI-RS. For example, the gNB 200 transmits the CSI-RS from all antenna ports of the antenna panel in a mode in which the UE 100 performs the model training. On the other hand, in the mode in which the UE 100 performs model inference, the gNB 200 reduces the number of antenna ports for transmitting the CSI-RSs, and transmits the CSI-RSs from half the antenna ports of the antenna panel. Note that the antenna port is an example of the resource. This can reduce the overhead, improve a utilization efficiency of the antenna ports, and give an effect of power consumption reduction.

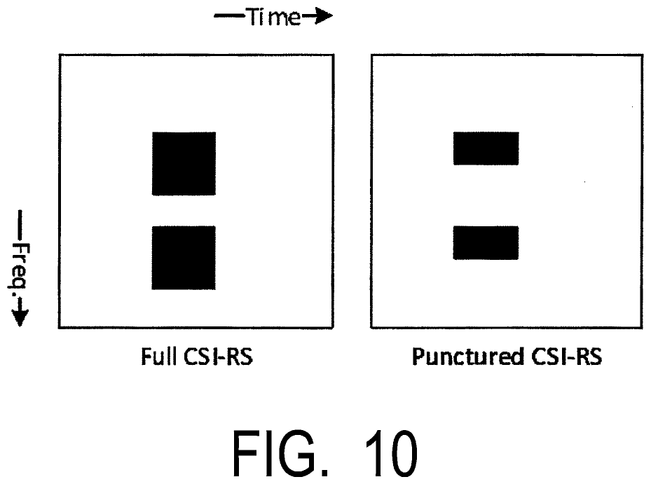

FIG. 10 is a diagram illustrating a second example of reducing the CSI-RSs according to an embodiment. In the second example, the gNB 200 reduces the number of radio resources for transmitting the CSI-RSs, specifically, the number of time-frequency resources. For example, the gNB 200 transmits the CSI-RS by using a predetermined time-frequency resource in a mode in which the UE 100 performs the model training. On the other hand, in a mode in which the UE 100 performs the model inference, the gNB 200 transmits the CSI-RS using a smaller amount of time-frequency resources than predetermined time-frequency resources. This can reduce the overhead, improve a utilization efficiency of the radio resources, and give an effect of power consumption reduction.

A first operation pattern relating to the first operation scenario is described. In the first operation pattern, the gNB 200 transmits a switching notification as the control data to the UE 100, the switching notification providing notification of mode switching between a mode for performing the model training (hereinafter, also referred to as a “training mode”) and a mode for performing model inference (hereinafter, also referred to as an “inference mode”). The UE 100 receives the switching notification and performs the mode switching between the training mode and the inference mode. This enables the mode switching to be appropriately performed between the training mode and the inference mode. The switching notification may be configuration information to configure a mode for the UE 100. The switching notification may also be a switching command for indicating to the UE 100 the mode switching.

In the first operation pattern, when the model training is completed, the UE 100 transmits a completion notification as the control data to the gNB 200, the completion notification indicating that the model training is completed. The gNB 200 receives the completion notification. This enables gNB 200 to grasp that the model training is completed on the UE 100 side.

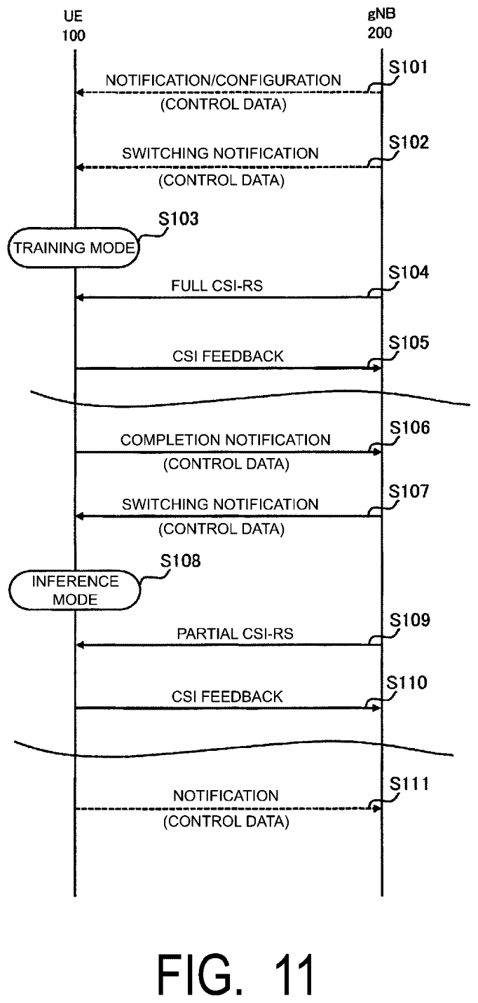

FIG. 11 is an operation flow diagram illustrating the first operation pattern relating to the first operation scenario according to an embodiment. This flow may be performed after the UE 100 establishes an RRC connection to the cell of the gNB 200. Note that in the operation flow described below, dashed lines indicate steps which may be omitted.

In step S101, the gNB 200 may notify the UE 100 of or configure for the UE, as the control data, an input data pattern in the inference mode, for example, a transmission pattern (puncture pattern) of the CSI-RS in the inference mode. For example, the gNB 200 notifies the UE 100 of the antenna port and/or the time-frequency resource for transmitting or not transmitting the CSI-RS in the inference mode.

In step S102, the gNB 200 may transmit a switching notification for starting the training mode to the UE 100.

In step S103, the UE 100 starts the training mode.

In step S104, the gNB 200 transmits a full CSI-RS. The UE 100 receives the full CSI-RS and generates CSI based on the received CSI-RS. In the training mode, the UE 100 may perform supervised learning using the received CSI-RS and CSI corresponding to the received CSI-RS. The UE 100 may derive and manage a training result (trained model) per communication environment of the UE 100, for example, per reception quality (RSRP, RSRQ, or SINR) and/or migration speed.

In step S105, the UE 100 transmits (feeds back) the generated CSI to the gNB 200.

Thereafter, in step S106, when the model training is completed, the UE 100 transmits a completion notification indicating that the model training is completed to the gNB 200. The UE 100 may transmit the completion notification to the gNB 200 when the derivation (generation or update) of the trained model is completed. Here, the UE 100 may transmit a notification indicating that learning is completed per communication environment (e.g., migration speed and reception quality) of the UE 100 itself. In this case, the UE 100 includes, in the notification, information indicating for which communication environment the completion notification is.

In step S107, the gNB 200 transmits, to the UE 100, a switching information notification for switching from the training mode to the inference mode.

In step S108, the UE 100 switches from the training mode to the inference mode in response to receiving the switching notification in step S107.

In step S109, the gNB 200 transmits a partial CSI-RS. Once receiving the partial CSI-RS, the UE 100 uses the trained model to infer CSI from the received CSI-RS. The UE 100 may select a trained model corresponding to the communication environment of the UE 100 itself from among trained models managed per communication environment, and may infer the CSI using the selected trained model.

In step S110, the UE 100 transmits (feeds back) the inferred CSI to the gNB 200.

In step S111, when the UE 100 determines that the model training is necessary, the UE 100 may transmit a notification as the control data to the gNB 200, the notification indicating that the model training is necessary. For example, the UE 100 considers that accuracy of the inference result cannot be guaranteed and transmits the notification to the gNB 200 when the UE 100 moves, the migration speed of the UE 100 changes, the reception quality of the UE 100 changes, the cell in which the UE exists changes, or the bandwidth part (BWP) the UE 100 uses for communication changes.

A second operation pattern relating to the first operation scenario is described. The second operation pattern may be used together with the above-described operation pattern. In the second operation pattern, the gNB 200 transmits a completion condition notification as the control data to the UE 100, the completion condition notification indicating a completion condition of the model training. The UE 100 receives the completion condition notification and determines completion of the model training based on the completion condition notification. This enables the UE 100 to appropriately determine the completion of the model training. The completion condition notification may be configuration information to configure the completion condition of the model training for the UE 100. The completion condition notification may be included in the switching notification providing notification of (indicating) switching to the training mode.

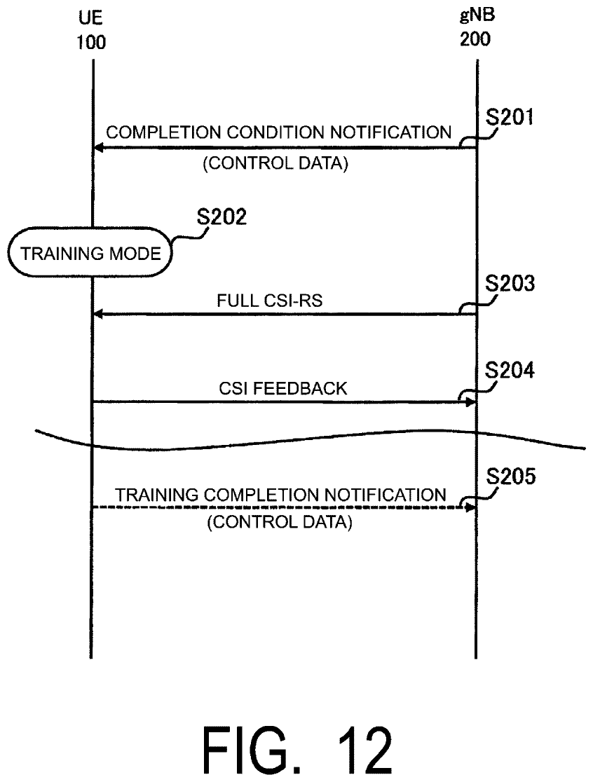

FIG. 12 is an operation flow diagram illustrating the second operation pattern relating to the first operation scenario according to an embodiment.

In step S201, the gNB 200 transmits the completion condition notification as the control data to the UE 100, the completion condition notification indicating the completion condition of the model training. The completion condition notification may include at least one selected from the group consisting of the following pieces of completion condition information.

### Acceptable Error Range for Correct Answer Data

For example, adopted is an acceptable range of an error between the CSI generated by using a normal CSI feedback calculation method and the CSI inferred by the model inference. At a stage where the learning has progressed to some extent, the UE 100 can infer the CSI by using the trained model at that point in time, compare the CSI with the correct CSI, and determine that the learning is completed based on that the error is within the acceptable range.

### The Number of Pieces of Training Data

The number of pieces of data used for learning. For example, the number of received CSI-RSs corresponds to the number of pieces of training data. The UE 100 can determine that the learning is completed based on that the number of received CSI-RSs in the training mode reaches the number of pieces of training data indicated by a notification (configuration).

### The Number of Learning Trials

The number of times the model training is performed using the training data. The UE 100 can determine that the learning is completed based on that the number of times of the learning in the training mode reaches the number of times indicated by a notification (configuration).

### Output Score Threshold Value

For example, a score in reinforcement learning. The UE 100 can determine that the learning is completed based on that the score reaches the score indicated by a notification (configuration).

The UE 100 continues the learning based on the full CSI-RS until determining that the learning is completed (steps S203 and S204).

In step S205, the UE 100, when determining that the model training is completed, may transmit a completion notification indicating that the model training is completed to the gNB 200.

A third operation pattern relating to the first operation scenario is described. The third operation pattern may be used together with the above-described operation patterns. When the accuracy of the CSI feedback is desired to be increased, not only the CSI-RS but also other types of data, for example, reception characteristics of a physical downlink shared channel (PDSCH) can be used as the training data and the inference data. In the third operation pattern, the gNB 200 transmits data type information as the control data to the UE 100, the data type information designating at least a type of data used as the training data. In other words, the gNB 200 designates what is to be the training data/inference data (type of input data) with respect to the UE 100. The UE 100 receives the data type information and performs the model training using the data of the designated data type. This enables the UE 100 to perform appropriate model training.

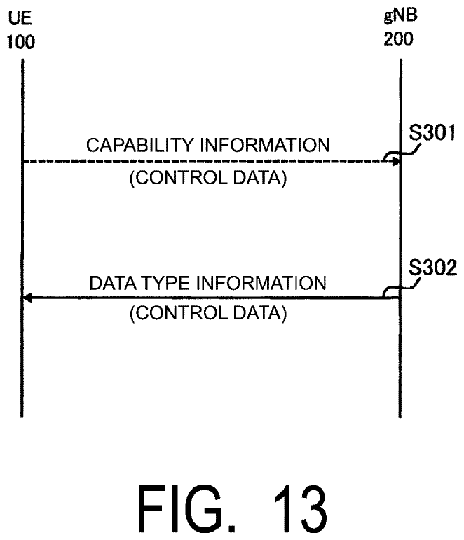

FIG. 13 is an operation flow diagram illustrating the third operation pattern relating to the first operation scenario according to an embodiment.

In step S301, the UE 100 may transmit capability information as the control data to the gNB 200, the capability information indicating which type of input data the UE 100 can handle in the machine learning. Here, the UE 100 may further transmit a notification indicating additional information such as the accuracy of the input data.

In step S302, the UE 100 transmits the data type information to the gNB 200. The data type information may be configuration information to configure a type of the input data for the UE 100. Here, the type of the input data may be the reception quality and/or UE migration speed for the CSI feedback. The reception quality may be reference signal received power (RSRP), reference signal received quality (RSRQ), signal-to-interference-plus-noise ratio (SINR), bit error rate (BER), block error rate (BLER), analog-to-digital converter output waveform, or the like.

Note that when UE positioning to be described below is assumed, the type of the input data may be position information (latitude, longitude, and altitude) of Global Navigation Satellite System (GNSS), RF fingerprint (cell ID, reception quality thereof, and the like), angle of arrival (AoA) of reception signal, reception level/reception phase/reception time difference (OTDOA) for each antenna, roundtrip time, and reception information of short-range wireless communication such as a wireless Local Area Network (LAN).

The gNB 200 may designate the type of the input data independently for each of the training data and the inference data. The gNB 200 may designate the type of input data independently for each of the CSI feedback and the UE positioning.

### Second Operation Scenario

A second operation scenario is described mainly on differences from the first operation scenario. The first operation scenario has mainly described the downlink reference signal (that is, downlink CSI estimation). The second operation scenario describes an uplink reference signal (that is, uplink CSI estimation). In the description of the second operation scenario, assume that the uplink reference signal is a sounding reference signal (SRS), but the uplink reference signal may be an uplink DMRS or the like.

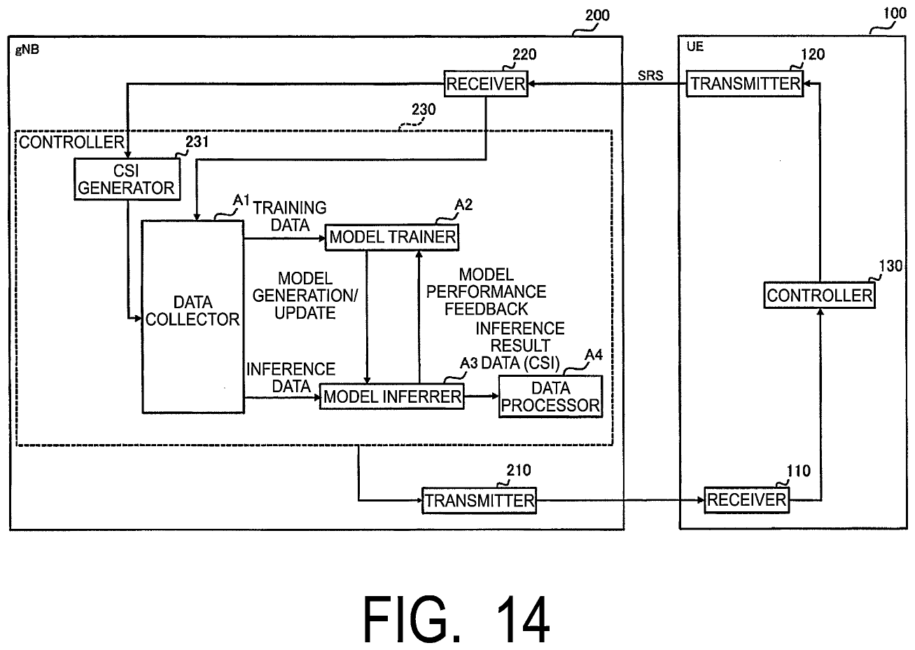

FIG. 14 is a diagram illustrating the second operation scenario according to an embodiment. In the second operation scenario, the data collector A1, the model trainer A2, the model inferrer A3, and the data processor A4 are arranged in the gNB 200 (e.g., the controller 230). In other words, the model training and the model inference are performed on the gNB 200 side.

In the second operation scenario, the machine learning technology is introduced into the CSI estimation performed by the gNB 200 based on the SRS from the UE 100. Therefore, the gNB 200 (e.g., the controller 230) includes a CSI generator 231 that generates CSI based on the SRS received by the receiver 220 from the UE 100. The CSI is information indicating an uplink channel state between the UE 100 and the gNB 200. The gNB 200 (e.g., the data processor A4) performs, for example, uplink scheduling based on the CSI generated based on the SRS.

First, in the model training, the gNB 200 (receiver 220) receives a first reference signal from the UE 100 by using a first resource. Then, the gNB 200 (model trainer A2) derives a trained model for inferring CSI from the reference signal (SRS) by using training data including the first reference signal. In the description of the second operation scenario, such a first reference signal may be referred to as a full SRS.

For example, the gNB 200 (CSI generator 231) performs channel estimation by using the reception signal (SRS) received by the receiver 220 from the UE 100, and generates CSI. The model trainer A2 performs model training by using a plurality of sets of the reception signal (SRS) and the CSI as the training data to derive a trained model for inferring the CSI from the reception signal (SRS).

Second, in the model inference, the gNB 200 (receiver 220) receives a second reference signal from the UE 100 by using a second resource that is less than the first resource. Then, the UE 100 (model inferrer A3) uses the trained model to infer the CSI as the inference result data from inference data including the second reference signal. In the description of the second operation scenario, such a second reference signal may be referred to as a partial SRS or a punctured SRS. For a puncture pattern of the SRS, the pattern that is the same as and/or similar to that in the first operation scenario can be used (see FIGS. 9 and 10).

For example, the gNB 200 (model inferrer A3) uses the reception signal (SRS) received by the receiver 220 from the UE 100 as the inference data, and infers the CSI from the reception signal (SRS) by using the trained model.

This enables the gNB 200 to generate accurate (complete) CSI from a small number of SRSs (partial SRSs) received from the UE 100. For example, the UE 100 may reduce (puncture) the SRS when intended for overhead reduction. The gNB 200 can cope with a situation in which a radio situation deteriorates and some SRSs cannot be normally received.

In such an operation scenario, “CSI-RS”, “gNB 200”, and “UE 100” in the operation of the first operation scenario described above can be read as “SRS”, “UE 100”, and “gNB 200”, respectively.

In the second operation scenario, the gNB 200 transmits reference signal type information as the control data to the UE 100, the reference signal type information indicating a type of either the first reference signal (full SRS) or the second reference signal (partial SRS) to be transmitted by the UE 100. The UE 100 receives the reference signal type information and transmits the SRS designated by the gNB 200 to the gNB 200. This can cause the UE 100 to transmit an appropriated SRS.

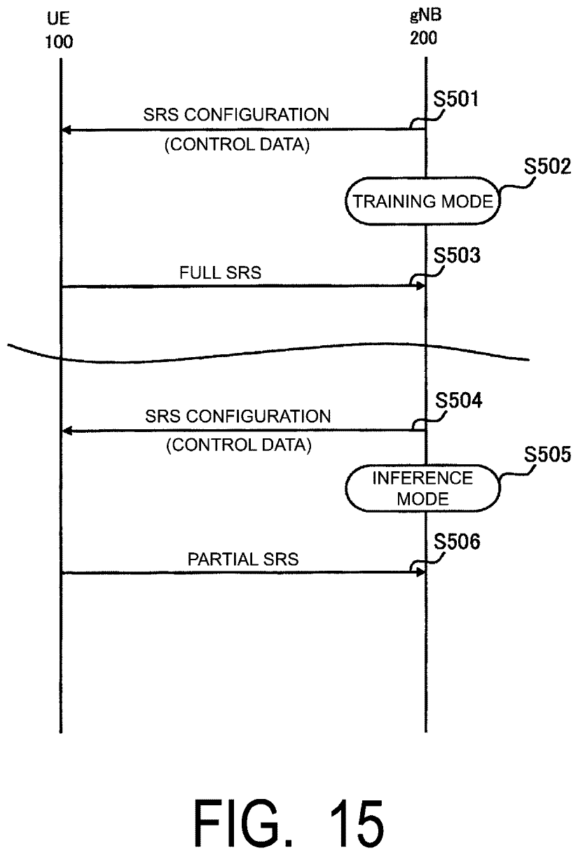

FIG. 15 is an operation flow diagram illustrating an operation example relating to the second operation scenario according to an embodiment.

In step S501, the gNB 200 performs SRS transmission configuration for the UE 100.

In step S502, the gNB 200 starts the training mode.

In step S503, the UE 100 transmits the full SRS to the gNB 200 in accordance with the configuration in step S501. The gNB 200 receives the full SRS and performs model training for channel estimation.

In step S504, the gNB 200 specifies the transmission pattern (puncture pattern) of the SRS to be input as the inference data to the trained model, and configures the specified SRS transmission pattern for the UE 100.

In step S505, the gNB 200 transitions to the inference mode and starts the model inference using the trained model.

In step S506, the UE 100 transmits the partial SRS in accordance with the SRS transmission configuration in step S504. When the gNB 200 inputs the SRS as the inference data to the trained model to obtain a channel estimation result, the gNB 200 performs uplink scheduling (e.g., control of uplink transmission weight and the like) of the UE 100 by using the channel estimation result. Note that when the inference accuracy by way of the trained model deteriorates, the gNB 200 may reconfigure so that the UE 100 transmits the full SRS.

### Third Operation Scenario

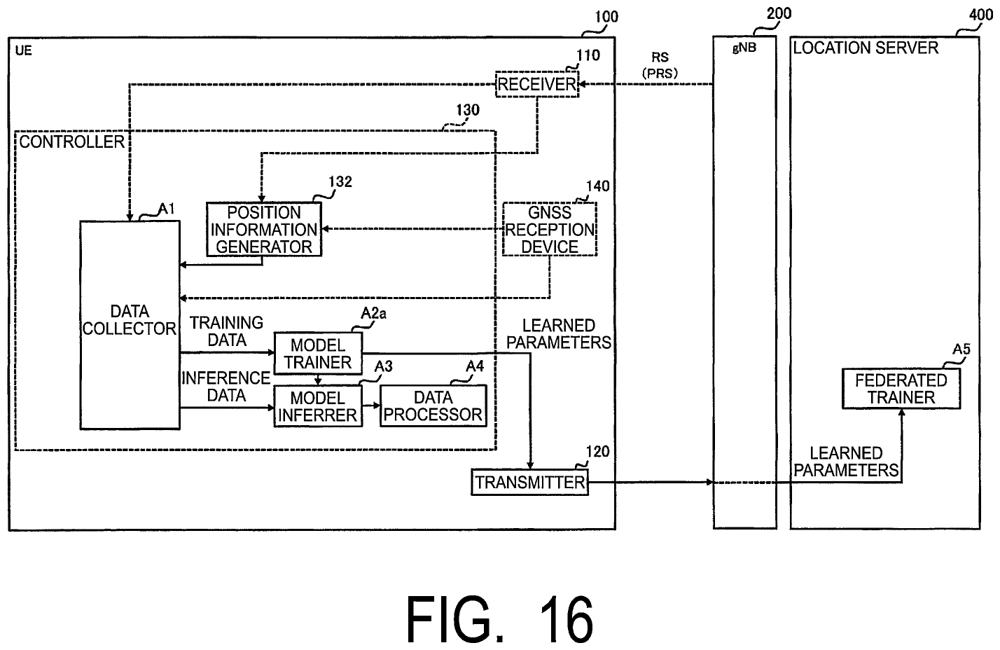

A third operation scenario is described mainly on differences from the first and second operation scenarios. The third operation scenario is an embodiment in which position estimation of the UE 100 (so-called UE positioning) is performed by using federated learning. FIG. 16 is a diagram illustrating the third operation scenario according to an embodiment. In an application example of such federated learning, for example, the following procedure is performed.

First, a location server 400 transmits a model to the UE 100.

Second, the UE 100 performs model training on the UE 100 (model trainer A2) side using the data in the UE 100. The data in the UE 100 may be, for example, a positioning reference signal (PRS) received by the UE 100 from the gNB 200 and/or output data from the GNSS reception device 140. The data in the UE 100 may include position information (including latitude and longitude) generated by the position information generator 132 based on the reception result of the PRS and/or the output data from the GNSS reception device 140.

Third, the UE 100 applies the trained model, which is the training result, to the UE 100 (model inferrer A3) and transmits variable parameters included in the trained model (hereinafter also referred to as “learned parameters”) to the location server 400. In the above example, the optimized a (slope) and b (intercept) correspond to the learned parameters.

Fourth, the location server 400 (federated trainer A5) collects the learned parameters

from a plurality of UEs 100 and integrates these parameters. The location server 400 may transmit the trained model obtained by the integration to the UE 100. The location server 400 can estimate the position of the UE 100 based on the trained model obtained by the integration and a measurement report from the UE 100.

In the third operation scenario, the gNB 200 transmits trigger configuration information as the control data to the UE 100, the trigger configuration information configuring a transmission trigger condition for the UE 100 to transmit the learned parameters. The UE 100 receives the trigger configuration information and transmits the learned parameters to the gNB 200 (location server 400) when the configured transmission trigger condition is satisfied. This enables the UE 100 to transmit the learned parameters at an appropriate timing.

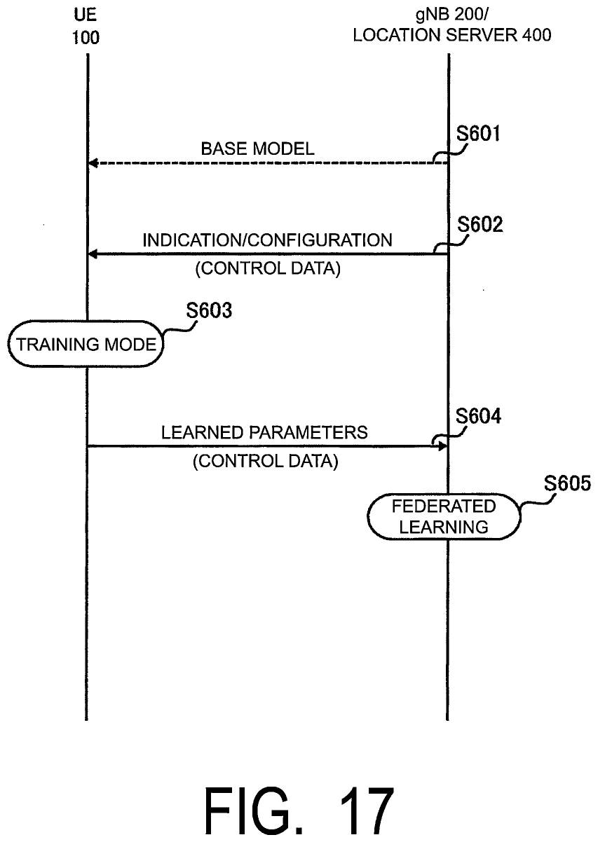

FIG. 17 is an operation flow diagram illustrating an operation example relating to the third operation scenario according to an embodiment.

In step S601, the gNB 200 may transmit a notification indicating a base model that the UE 100 trains. Here, the base model may be a model trained in the past. As described above, the gNB 200 may transmit the data type information indicating what is to be input data to the UE 100.

In step S602, the gNB 200 indicates the model training to the UE 100 and configures a report timing (trigger condition) of the learned parameter. The configured report timing may be a periodic timing. The configured report timing may be a timing triggered by learning proficiency satisfying a condition (that is, an event trigger).

For the periodic timing, the gNB 200 sets, for example, a timer value in the UE 100. The UE 100 starts a timer when starting learning (step S603) and reports the learned parameters to the gNB 200 (location server 400) when the timer expires (step S604). The gNB 200 may designate a radio frame or time to be reported to the UE 100. The radio frame may be designated as an absolute value, e.g., SFN=512. The radio frame may be calculated by using a modulo operation. For example, the gNB 200 reports the learned parameters at the SFN that “SFN mod N=0” holds for the UE 100, where Nis a set value (step S604).

For the event trigger, the completion condition as described above is configured for the UE 100. The UE 100 reports the learned parameters to the gNB 200 (location server 400) when the completion condition is satisfied (step S604). The UE 100 may trigger the reporting of the learned parameters, for example, when the accuracy of the model inference is better than the previously transmitted model. Here, the UE 100 may introduce an offset to trigger when “current accuracy>previous accuracy+offset” holds. The UE 100 may trigger the reporting of the learned parameters, for example, when the training data is input (learned) N times or more. Such an offset and/or a value of N may be configured by the gNB 200 for the UE 100.

In step S604, when the condition of the report timing is satisfied, the UE 100 reports the learned parameters at that time to the network (gNB 200).

In step S605, the network (location server 400) integrates the learned parameters reported from a plurality of UEs 100.

### First Operation Pattern Relating to Model Transfer

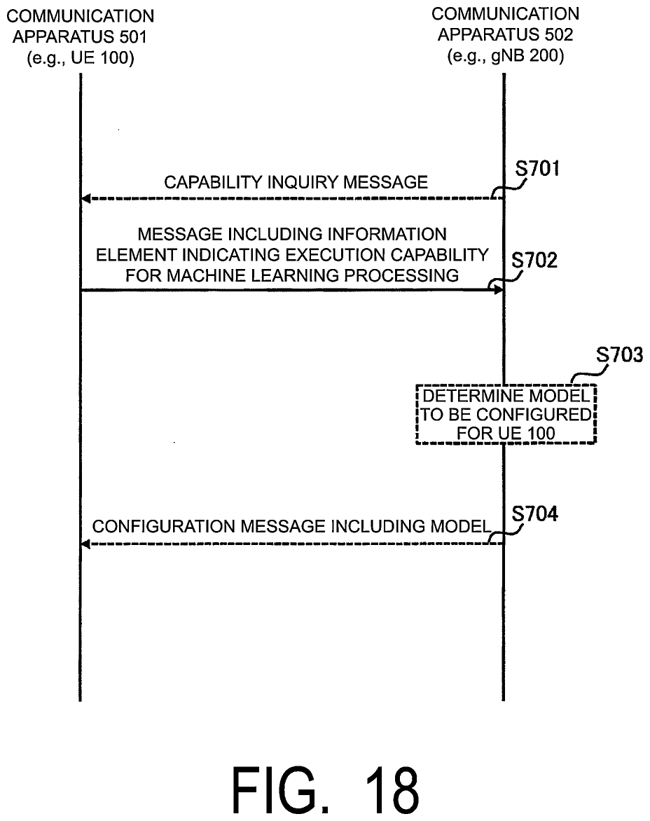

FIG. 18 is a diagram illustrating a first operation pattern relating to model transfer according to an embodiment. In the drawings referenced in the following embodiment, non-essential processing is indicated by a dashed line. In the following embodiment, it is assumed that the communication apparatus 501 is mainly the UE 100, but the communication apparatus 501 may be the gNB 200 or the AMF 300A. It is assumed that the communication apparatus 502 is mainly the gNB 200, but the communication apparatus 502 may be the UE 100 or the AMF 300A.

As illustrated in FIG. 18, in step S701, the gNB 200 transmits, to the UE 100, a capability inquiry message for requesting transmission of the message including the information element indicating the execution capability for the machine learning processing. The capability inquiry message is an example of the transmission request for requesting transmission of the message including the information element indicating the execution capability for the machine learning processing. The UE 100 receives the capability inquiry message. However, the gNB 200 may transmit the capability inquiry message when performing the machine learning processing (when determining to perform the machine learning process).

In step S702, the UE 100 transmits, to the gNB 200, the message including the information element indicating the execution capability (an execution environment for the machine learning processing, from another viewpoint) for the machine learning processing. The gNB 200 receives the message. The message may be an RRC message, for example, a “UE Capability” message defined in the RRC technical specifications, or a newly defined message (e.g., a “UE AI Capability” message or the like). The communication apparatus 502 may be the AMF 300A and the message may be a NAS message. When a new layer for performing or controlling the machine learning processing (AI/ML processing) is defined, the message may be a message of the new layer. The new layer is adequately referred to as an “AI/ML layer”.

The information element indicating the execution capability for the machine learning processing is at least one selected from group consisting of the information elements (A1) to (A3) below.

### Information Element (A1)

The information element (A1) is an information element indicating capability of the processor for performing the machine learning processing and/or an information element indicating capability of the memory for performing the machine learning processing.

The information element indicating the capability of the processor for performing the machine learning processing may be an information element indicating whether the UE 100 includes an AI processor. When the UE 100 includes the processor, the information element may include an AI processor product number (model number). The information element may be an information element indicating whether a Graphics Processing Unit (GPU) is usable by the UE 100. The information element may be an information element indicating whether the machine learning processing needs to be performed by the CPU. It is possible to determine at the network side whether, for example, a neural network model is usable as a model by the UE 100, by transmitting the information element indicating the capability of the processor for executing the machine learning processing from the UE 100 to the gNB 200. The information element indicating the capability of the processor for performing the machine learning processing may be an information element indicating a clock frequency and/or the number of parallel executables for the processor.

The information element indicating the capability of the memory for performing the machine learning processing may be an information element indicating a memory capacity of a volatile memory (e.g., a Random Access Memory (RAM)) of the memories of the UE 100. The information elements may be an information element indicating a memory capacity of a non-volatile memory (e.g., a Read Only Memory (ROM)) of the memories of the UE 100. The information element may indicate both of these. The information element indicating the capability of the memory for performing the machine learning processing may be defined for each type such as a model storage memory, an AI processor memory, or a GPU memory.

The information element (A1) may be defined as an information element for the inference processing (model inference). The information element (A1) may be defined as an information element for the learning processing (model training). Both the information element for the inference processing and the information element for the learning processing may be defined as the information element (A1).

### Information Element (A2)

The information element (A2) is an information element indicating the execution capability for the inference processing. The information element (A2) may be an information element indicating a model supported in the inference processing. The information element may be an information element indicating whether a deep neural network model is able to be supported. In this case, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A2) may be an information element indicating the execution time (response time) required to perform the inference processing. The information element (A2) may be an information element indicating the number of simultaneous executions of the inference processing (e.g., how many pieces of inference processing can be performed in parallel). The information element (A2) may be an information element indicating the processing capacity of the inference processing. For example, when a processing load for a certain standard model (standard task) is determined to be one point, the information element indicating the processing capacity of the inference processing may be information indicating how many points the processing capacity of the inference processing itself is.

### Information Element (A3)

The information element (A3) is an information element indicating the execution capability for the learning processing. The information element (A3) may be an information element indicating a learning algorithm supported in the learning processing. Examples of the learning algorithm indicated by the information element include supervised learning (e.g., linear regression, decision tree, logistic regression, k-nearest neighbor algorithm, and support vector machine), unsupervised learning (e.g., clustering, k-means, and principal component analysis), reinforcement learning, and deep learning. When the UE 100 supports deep learning, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A3) may be an information element indicating the execution time (response time) required to perform the learning processing. The information element (A3) may be an information element indicating the number of simultaneous executions of the learning processing (e.g., how many pieces of learning processing can be performed in parallel). The information element (A3) may be an information element indicating the processing capacity of the learning processing. For example, when a processing load for a certain standard model (standard task) is determined to be one point, the information element indicating the processing capacity of the learning processing may be information indicating how many points the processing capacity of the learning processing itself is. Note that since the processing load of the learning processing is generally higher than that of the inference processing, the number of simultaneous executions may be information such as the number of simultaneous executions with the inference processing (e.g., two pieces of inference processing and one piece of learning processing).

In step S703, the gNB 200 determines a model to be configured (deployed) for the UE 100 based on the information element included in the message received in step S702. The model may be a trained model used by the UE 100 in the inference processing. The model may be an untrained model used by the UE 100 in the learning processing.

In step S704, the gNB 200 transmits a message including the model determined in step S703 to the UE 100. The UE 100 receives the message and performs the machine learning processing (learning processing and/or inference processing) using the model included in the message. A specific example of step S704 is described in the second operation pattern below.

### Second Operation Pattern Relating to Model Transfer

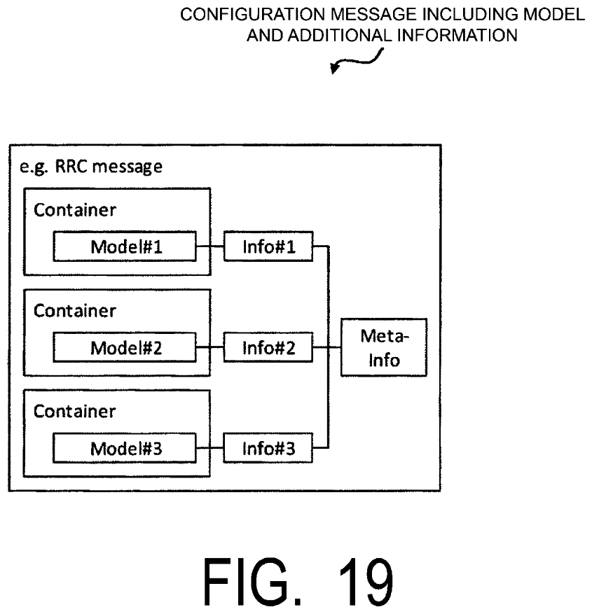

FIG. 19 is a diagram illustrating an example of a configuration message including models and additional information according to an embodiment. The configuration message may be an RRC message transmitted from the gNB 200 to the UE 100, for example, an “RRC Reconfiguration” message defined in the RRC technical specifications, or a newly defined message (such as an “AI Deployment” message or an “AI Reconfiguration” message). The configuration message may be a NAS message transmitted from the AMF 300A to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

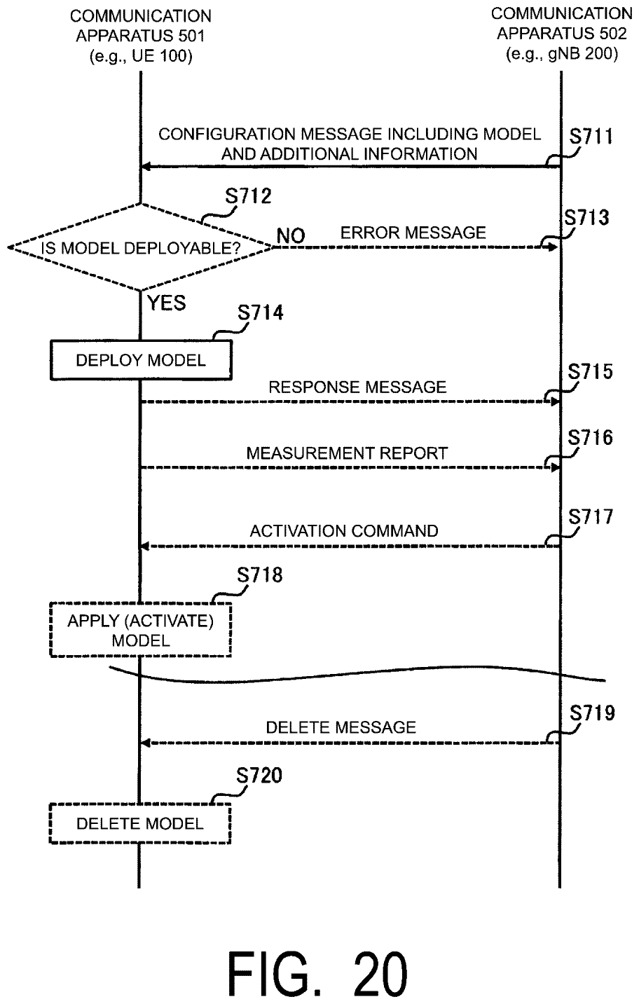

FIG. 20 is a diagram illustrating the second operation pattern relating to model transfer according to an embodiment.

In step S711, the gNB 200 transmits a configuration message including a model and additional information to the UE 100. The UE 100 receives the configuration message. The configuration message includes at least one selected from the group consisting of the information elements (B1) to (B6) below.

### (B1) Model

The “model” may be a trained model used by the UE 100 in the inference processing. The “model” may be an untrained model used by the UE 100 in the learning processing. In the configuration message, the “model” may be encapsulated (containerized). When the “model” is a neural network model, the “model” may be represented by the number of layers (stages), the number of neurons per layer, a synapse (weight) between the neurons, and the like. For example, a trained (or untrained) neural network model may be represented by a combination of matrices.

A plurality of “models” may be included in one configuration message. In this case, the plurality of “models” may be included in the configuration message in a list format. The plurality of “models” may be configured for the same application or may be configured for different applications. The application of the model is described in detail below.

### (B2) Model Index

A “model index” is an example of the additional information (e.g., individual additional information). The “model index” is an index (index number) assigned to a model. In the activation command and the delete message described below, a model can be designated by the “model index”. When the configuration change of the model is performed, a model can be designated by the “model index” as well.

### (B3) Model Application

The “model application” is an example of the additional information (individual additional information or common additional information). The “model application” designates a function to which a model is applied. For example, examples of the functions to which the model is applied include CSI feedback, beam management (beam estimation, overhead latency reduction, beam selection accuracy improvement), positioning, modulation and demodulation, coding and decoding (CODEC), and packet compression. The contents of the model application and indexes (identifiers) thereof may be predefined in the 3GPP technical specifications, and the “model application” may be designated by the index. For example, the model application and the index (identifier) thereof are defined such that the CSI feedback is assigned with an application index #A and the beam management is assigned with an application index #B. The UE 100 deploys the model for which the “model application” is designated to the functional block corresponding to the designated application. Note that the “model application” may be an information element that designates input data and output data of a model.

### (B4) Model Execution Requirement

A “model execution requirement” is an example of the additional information (e.g., individual additional information). The “model execution requirement” is an information element indicating a performance required to apply (execute) the model (required performance), for example, a processing delay (request latency).

### (B5) Model Selection Criterion

A “model selection criterion” is an example of the additional information (individual additional information or common additional information). In response to a criterion designated by the “model selection criterion” being met, the UE 100 applies (executes) the corresponding model. The “model selection criterion” may be the migration speed of the UE 100. In this case, the “model selection criterion” may be designated by a speed range such as “low-speed migration” or “high-speed migration”. The “model selection criterion” may be designated by a threshold value of the migration speed. The “model selection criterion” may be a radio quality (e.g., RSRP/RSRQ/SINR) measured in the UE 100. In this case, the “model selection criterion” may be designated by a range of the radio quality. The “model selection criterion” may be designated by a threshold value of the radio quality. The “model selection criterion” may be a position (latitude/longitude/altitude) of the UE 100. The “model selection criterion” may be configured so as to sequentially conform to a notification (activation command described later) from a network. As the “model selection criterion”, an autonomous selection by the UE 100 may be designated.

### (B6) Whether to Require Learning Processing

The “whether to require learning processing” is an information element indicating whether the learning processing (or relearning) on the corresponding model is required or is able to be performed. When the learning processing is required, parameter types used for the learning processing may be further configured. For example, for the CSI feedback, the CSI-RS and the UE migration speed are configured to be used as parameters. When the learning processing is required, a method of the learning processing, for example, supervised learning, unsupervised learning, reinforcement learning, or deep learning may be further configured. Whether the learning processing is performed immediately after the model is configured may be further configured. When the learning processing is not performed immediately, learning execution may be controlled by the activation command described below. For example, for the federated learning, whether to notify the gNB 200 of a result of the learning processing of the UE 100 may be further configured. When a notification of the result of the learning processing of the UE 100 is required to be provided to the gNB 200, the UE 100, after performing the learning processing, may encapsulate and transmit the trained model or the learned parameter to the gNB 200 by using an RRC message or the like. The information element indicating “whether to require learning processing” may be an information element indicating, in addition to whether to require learning processing, whether the corresponding model is used only for the model inference.

In step S712, the UE 100 determines whether the model configured in step S711 is deployable (executable). The UE 100 may make this determination at the time of activation of the model, which is described below, and in step S713, which is described later, a message may be transmitted for a notification of an error at the time of the activation. The UE 100 may make the determination during using the model (during performing the machine learning processing) instead of the time of the deployment or the activation. When the model is determined to be non-deployable (NO in step S712), that is, when an error occurs, in step S713, the UE 100 transmits an error message to the gNB 200. The error message may be an RRC message transmitted from the UE 100 to the gNB 200, for example, a “Failure Information” message defined in the RRC technical specifications, or a newly defined message (e.g., an “AI Deployment Failure Information” message). The error message may be Uplink Control Information (UCI) defined in the physical layer or a MAC control element (CE) defined in the MAC layer. The error message may be a NAS message transmitted from the UE 100 to the AMF 300A. When a new layer (AI/ML layer) for performing the machine learning processing (AI/ML processing) is defined, the message may be a message of the new layer.

The error message includes at least one selected from the group consisting of the information elements (C1) to (C3).

### (C1) Model Index

This is a model index of the model determined to be non-deployable.

### (C2) Application Index

This is an application index of the model determined to be non-deployable.

### (C3) Error Cause

This is an information element related to a cause of an error. The “error cause” may be, for example, “unsupported model”, “processing capacity exceeded”, “error occurrence phase”, or “other errors”. Examples of the “unsupported model” include, for example, a model for which the UE 100 cannot support a neural network model, or a model for which the machine learning processing (AI/ML processing) of a designated function cannot be supported. Examples of the “processing capacity exceeded” include, for example, an overload (a processing load or/and a memory load exceed a capacity), the request processing time being not able to be satisfied, and an interrupt processing or a priority processing of an application (upper layer). The “error occurrence phase” is information indicating when an error has occurred. The “error occurrence phase” may include a classification such as a time of deployment (configuration) time, a time of activation time, or a time of operation. The “error occurrence phase” may include a classification such as a time of inference processing or a time of learning processing. The “other errors” include other causes.

The UE 100 may automatically delete the corresponding model when an error occurs. The UE 100 may delete the model when confirming that an error message is received by the gNB 200, for example, when an ACK is received at the lower layer. The gNB 200, when receiving an error message from the UE 100, may recognize that the model has been deleted.

On the other hand, when the model configured in step S711 is determined to be deployable (YES in step S712), that is, when no error occurs, in step S714, the UE 100 deploys the model in accordance with the configuration. The “deployment” may mean bringing the model into an applicable state. The “deployment” may mean actually applying the model. In the former case, the model is not applied when the model is only deployed, but the model is applied when the model is activated by the activation command described below. In the latter case, once the model is deployed, the model is brought into a state of being used.

In step S715, the UE 100 transmits a response message to the gNB 200 in response to the model deployment being completed. The gNB 200 receives the response message. The UE 100 may transmit the response message when the activation of the model is completed by the activation command described below. The response message may be an RRC message transmitted from the UE 100 to the gNB 200, for example, an “RRC Reconfiguration Complete” message defined in the RRC technical specifications, or a newly defined message (e.g., an “AI Deployment Complete” message). The response message may be a MAC CE defined in the MAC layer. The response message may be a NAS message transmitted from the UE 100 to the AMF 300A. When a new layer for performing the machine learning processing (AI/ML processing) is defined, the message may be a message of the new layer.

In step S716, the UE 100 may transmit a measurement report message to the gNB 200, the measurement report message being an RRC message including a measurement result of a radio environment. The gNB 200 receives the measurement report message.

In step S717, the gNB 200 selects a model to be activated, for example, based on the measurement report message, and transmits an activation command (selection command) for activating the selected model to the UE 100. The UE 100 receives the activation command. The activation command may be DCI, a MAC CE, an RRC message, or a message of the AI/ML layer. The activation command may include a model index indicating the selected model. The activation command may include information designating whether the UE 100 performs the inference processing or whether the UE 100 performs the learning processing.

The gNB 200 selects a model to be deactivated, for example, based on the measurement report message, and transmits a deactivation command (selection command) for deactivating the selected model to the UE 100. The UE 100 receives the deactivation command. The deactivation command may be DCI, a MAC CE, an RRC message, or a message of the AI/ML layer. The deactivation command may include a model index indicating the selected model. The UE 100, upon receiving the deactivation command, may not need to delete but may deactivate (cease to apply) the designate model.

In step S718, the UE 100 applies (activates) the designated model in response to receiving the activation command. The UE 100 performs the inference processing and/or the learning processing using the activated model from among the deployed models.

In step S719, the gNB 200 transmits a delete message to delete the model to the UE 100. The UE 100 receives the delete message. The delete message may be a MAC CE, an RRC message, a NAS message, or a message of the AI/ML layer. The delete message may include the model index of the model to be deleted. The UE 100, upon receiving the delete message, deletes the designated model.

### Third Operation Pattern Relating to Model Transfer

In the third operation pattern, the UE 100 notifies the network of the load status of the machine learning processing (AI/ML processing). This allows the network (e.g., the gNB 200) to determine how many more models can be deployed (or activated) in the UE 100 based on the load status transmitted in the notification. The third operation pattern may not need to be premised on the first operation pattern for the model transfer described above. The third operation pattern may be premised on the first operation pattern.

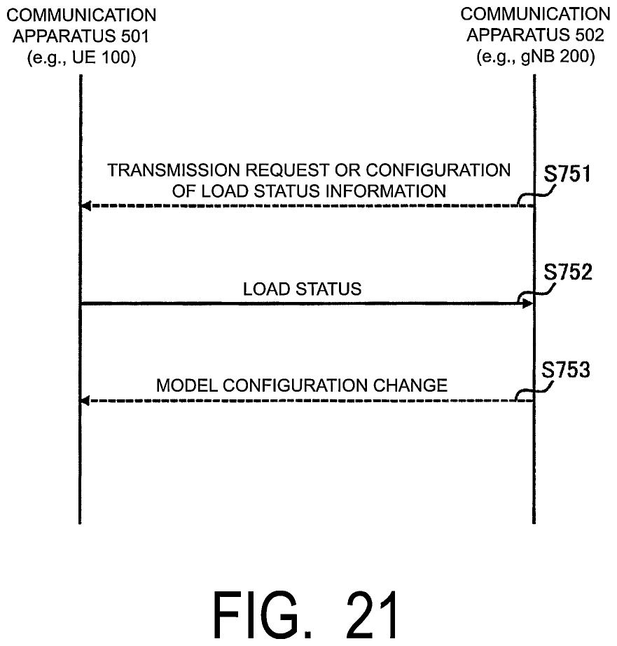

FIG. 21 is a diagram illustrating the third operation pattern relating to model transfer according to an embodiment.

In step S751, the gNB 200 transmits a message, to the UE 100, the message including a request for providing information on the AI/ML processing load status or a configuration of AI/ML processing load status reporting. The UE 100 receives the message. The message may be a MAC CE, an RRC message, a NAS message, or a message of the AI/ML layer. The configuration of AI/ML processing load status reporting may include information for configuring a report trigger (transmission trigger), for example, “Periodic” or “Event triggered”. “Periodic” configures a reporting period, and the UE 100 performs reporting in the period. “Event triggered” configures a threshold value to be compared with a value (processing load value and/or memory load value) indicating the AI/ML processing load status in the UE 100, and the UE 100 performs reporting in response to the value satisfying a condition of the threshold value. Here, the threshold value may be configured for each model. For example, in the message, the model index and the threshold value may be associated with each other.

In step S752, the UE 100 transmits a message (report message) including the AI/ML processing load status to the gNB 200. The message may be an RRC message, for example, a “UE Assistance Information” message or “Measurement Report” message. The message may be a newly defined message (e.g., an “AI Assistance Information” message). The message may be a NAS message, or may be a message of the AI/ML layer.

The message includes a “processing load status” and/or a “memory load status”. The “processing load status” may indicate what percentage of processing capability (capability of the processor) is already used or what remaining percentage is usable. The “processing load status” may indicate, with the load expressed in points as described above, how many points are already used and how many remaining points is usable. The UE 100 may indicate the “processing load status” for each model. For example, the UE 100 may include at least one set of “model index” and “processing load status” in the message. The “memory load status” may indicate a memory capacity, a memory usage amount, or a memory remaining amount. The UE 100 may indicate the “memory load status” for each type such as a model storage memory, an AI processor memory, and a GPU memory.

In step S752, when the UE 100 wants to stop using a particular model, for example, because of a high processing load or inefficiency, the UE 100 may include in the message information (model index) indicating a model of which configuration deletion or deactivation of model is wanted. When the processing load of the UE 100 becomes unsafe, the UE 100 may transmit the message including alert information to the gNB 200.

In step S753, the gNB 200 determines configuration change of the model or the like based on the message received from the UE 100 in step S752, and transmits a message for model configuration change to the UE 100. The message may be a MAC CE, an RRC message, a NAS message, or a message of the AI/ML layer. The gNB 200 may transmit the activation command or deactivation command described above to the UE 100.

### Model Management

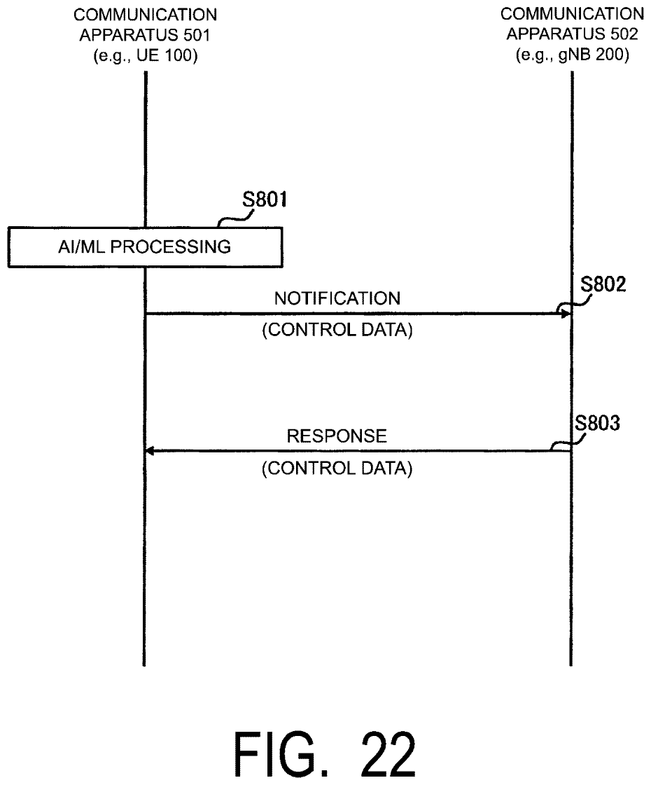

FIG. 22 is a diagram illustrating an example of model management according to an embodiment.

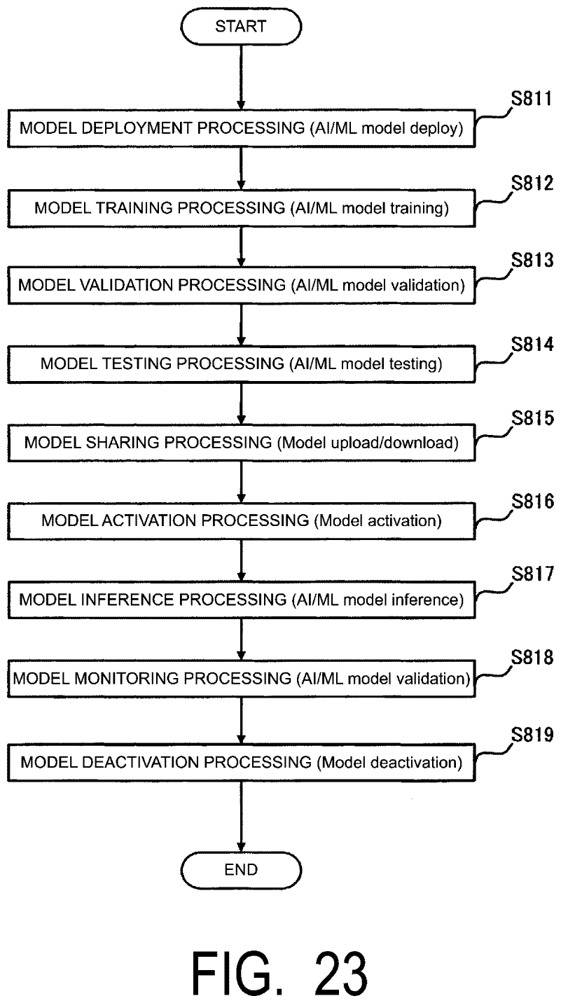

In step S801, the communication apparatus 501 performs AI/ML processing (machine learning processing). The machine learning processing is one of the steps illustrated in FIG. 23 to be described later.

In step S802, the communication apparatus 501 transmits a notification related to the

machine learning processing to the communication apparatus 502 as control data. The communication apparatus 502 receives the notification.

In step S802, the communication apparatus 501 transmits a notification indicating at least one selected from the group consisting of including an untrained model, including a model in training, and including a trained model on which testing has been completed to the communication apparatus 502, for example.

In step S803, the communication apparatus 502 transmits a response corresponding to the notification of step S802 to the communication apparatus 501 as control data. The communication apparatus 501 receives the response.

The notification of step S802 may be a notification indicating that the communication apparatus 501 includes the untrained model. In this case, in step S803, a data set and/or a configuration parameter to be used for the model training may be included.

The notification of step S802 may be a notification indicating that the communication apparatus 501 includes the model in training. In this case, the response of step S803 may include a data set to continue the model training.

The notification of step S802 may be a notification indicating that the communication apparatus 501 includes the trained model on which testing has been completed. The response of step S803 may include information to start use of the trained model on which testing has been completed.

Each of the notification of step S802 and the response of step S803 may include an index of the corresponding model and/or identification information for identifying a type or an application (for example, for CSI feedback, for beam management, for positioning, or the like) of the corresponding model. These pieces of information are hereinafter also referred to as “model application information and the like”.

FIG. 23 is a diagram illustrating details of model management, specifically, step S801 of FIG. 22, according to an embodiment.

In step S811, the communication apparatus 501 performs model deployment processing. Here, the communication apparatus 501 notifies the communication apparatus 502 that the communication apparatus 501 includes an untrained model, that is, includes a model that needs to be trained. For example, the untrained model may be pre-installed when the communication apparatus 501 is shipped. The untrained model may be acquired by the communication apparatus 501 from the communication apparatus 502. When the model training has not been completed, for example, certain quality has not been satisfied, the communication apparatus 501 may notify the communication apparatus 502 that the communication apparatus 501 includes the untrained model. For example, one example of a case is that, even if the model training has been completed once, quality of the model can no longer be secured in monitoring due to movement to another environment (for example, from the indoors to the outdoors). The communication apparatus 502 may provide a training data set to the communication apparatus 501, based on the notification. The communication apparatus 502 may perform an additional configuration for the communication apparatus 501. The communication apparatus 502 may perform exclusion of application, for example, discarding, deconfiguration (deconfig.), or deactivation, of the model.

In step S812, the communication apparatus 501 performs model training processing. The communication apparatus 501 notifies the communication apparatus 502 that the communication apparatus 501 is in the process of the model training. The notification may include the model application information and the like, in a manner that is the same as and/or similar to the above. The communication apparatus 502 continues to provide the training data set to the communication apparatus 501, based on the notification. Note that, when the communication apparatus 502 receives a notification indicating “prior to learning” or “in the process of learning”, the communication apparatus 502 may recognize that the communication apparatus 501 applies a known technique with no model application.

In step S813, the communication apparatus 501 performs model validation processing. The model validation processing is sub-processing of the model training processing. The model validation processing is processing of evaluating quality of the AI/ML model using a data set different from the data set used for the model training and thereby selecting (adjusting) a model parameter. The communication apparatus 501 may notify the communication apparatus 502 that the communication apparatus 501 is in the process of the model training or model validation has been completed.

In step S814, the communication apparatus 501 performs model testing processing. The model testing processing is sub-processing of the model training processing. In the model testing processing, a performance of a final AI/ML model is evaluated using a data set different from the data sets used for the model training and the model validation. Unlike the model validation, the model is not adjusted in the model testing. The communication apparatus 501 notifies the communication apparatus 502 that the communication apparatus 501 includes a tested model (that is, that can secure certain quality). The notification may include the model application information and the like, in a manner that is the same as and/or similar to the above. The communication apparatus 502 performs processing to start use of the model, for example, configuration or activation of the model, based on the notification. The communication apparatus 502 may determine to provide an inference data set, and perform configuration necessary for the communication apparatus 501.

In step S815, the communication apparatus 501 performs model sharing processing. For example, the communication apparatus 501 transmits (uploads) the trained model to the communication apparatus 502.

In step S816, the communication apparatus 501 performs model activation processing. The model activation processing is processing for activating (enabling) the model for a specific function. The communication apparatus 501 may notify the communication apparatus 502 that the communication apparatus 501 has activated the model. The notification may include the model application information and the like, in a manner that is the same as and/or similar to the above.

In step S817, the communication apparatus 501 performs model inference processing. The model inference processing is processing of generating a set of outputs based on a set of inputs, using the trained model. The communication apparatus 501 may notify the communication apparatus 502 that the communication apparatus 501 has performed the model inference. The notification may include the model application information and the like, in a manner that is the same as and/or similar to the above.

In step S818, the communication apparatus 501 performs model monitoring processing. The model monitoring processing is processing of monitoring inference a performance of the AI/ML model. The communication apparatus 501 may transmit a notification related to the model monitoring processing to the communication apparatus 502. The notification may include the model application information and the like, in a manner that is the same as and/or similar to the above. A specific example of the notification will be described later.

In step S819, the communication apparatus 501 performs model deactivation processing. The model deactivation processing is processing of deactivating (disabling) the model for a specific function. The communication apparatus 501 may notify the communication apparatus 502 that the communication apparatus 501 has deactivated the model. The notification may include the model application information and the like, in a manner that is the same as and/or similar to the above. The model deactivation processing may be processing of deactivating the currently active model and activating another model. The processing is also referred to as model switching.

### First Operation Pattern Relating to Model Monitoring

In the first operation pattern, the communication apparatus 501 performs the inference processing, using a trained model obtained by training the model. The communication apparatus 501 determines necessity of retraining the model by monitoring a performance of the trained model. In response to determining that the retraining is necessary, the communication apparatus 501 transmits a notification indicating the necessity of the retraining to the communication apparatus 502. Thus, the communication apparatus 502 can provide training data to be used for the retraining to the communication apparatus 501.

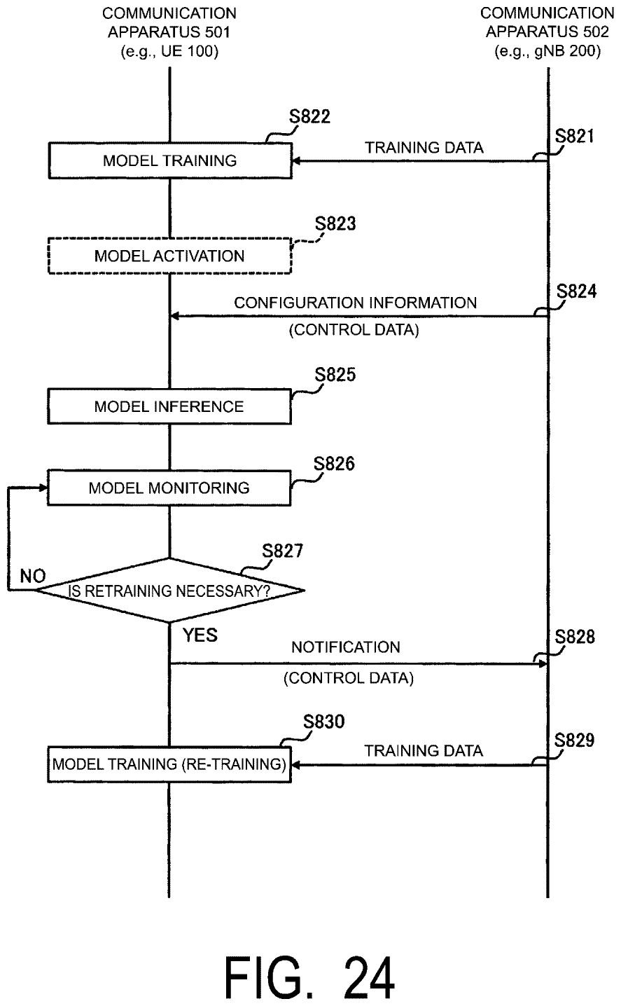

FIG. 24 is a diagram illustrating the first operation pattern relating to model monitoring according to an embodiment.

As illustrated in FIG. 24, in step S821, the communication apparatus 502 provides training data (training data set) to the communication apparatus 501. The training data may be a full CSI-RS, for example.

In step S822, the communication apparatus 501 performs the model training using the training data, and thereby generates a trained model.

In step S823, the communication apparatus 501 may activate the model.

In step S824, the communication apparatus 502 transmits configuration information including a parameter related to monitoring (monitoring processing) of model performance to the communication apparatus 501 as control data. The communication apparatus 501 receives the configuration information. The communication apparatus 501 performs the model monitoring processing of monitoring the performance of the trained model, using the parameter included in the configuration information (step S826).

The configuration information includes at least one selected from the group consisting of a model index (or an application) to be monitored, a threshold value for monitoring, and a transmission condition of a monitoring result report. The threshold value (monitoring threshold value) is a threshold value to be compared with a value indicating the inference performance of the model in the model monitoring, and is used to determine whether the performance of the model satisfies a certain criterion. The transmission condition of the monitoring result report may be a periodic report or an event trigger (when the monitoring threshold value is no longer satisfied or the like), for example.

In step S825, the communication apparatus 501 performs the model inference using the model.

In step S826, the communication apparatus 501 starts to monitor the model.

In step S827, the communication apparatus 501 determines whether the performance of the model satisfies the certain criterion, that is, whether retraining the model is necessary.

When the performance of the model does not satisfy the certain criterion, that is, it is determined that the retraining the model is necessary (step S827: YES), in step S828, the communication apparatus 501 transmits a notification as control data to the communication apparatus 502. The notification may be a notification of requesting provision of the training data set, and may include identification information for identifying a data set type (for example, a full CSI-RS) that is requested to be provided, for example. The notification may be a notification that the retraining the model is necessary, and may include a model index and/or identification information for identifying a model type/application (CSI inference, beamforming inference, position inference, or the like), for example.

In step S829, the communication apparatus 502 provides the requested training data set to the communication apparatus 501. For example, the communication apparatus 502 starts transmission of a full CSI-RS.

In step S830, the communication apparatus 501 performs the model training (retraining) using the training data, and thereby modifies the trained model (for example, adjusts the model parameter).

### Second Operation Pattern Relating to Model Monitoring

In the second operation pattern, the communication apparatus 501 receives configuration information including a monitoring parameter to monitor the performance of the trained model from the communication apparatus 502. The communication apparatus 501 performs the model monitoring processing using a monitoring data set, based on the configuration information. The second operation pattern may be performed in combination with the first operation pattern relating to model monitoring described above.

Here, the monitoring parameter may include time information indicating a time during which the monitoring data set is provided (that is, a monitoring time period) from the communication apparatus 502. The communication apparatus 501 may receive the monitoring data set from the communication apparatus 502 and perform the model monitoring processing during the time indicated by the time information. The monitoring parameter may include use condition information indicating a condition of reducing and using the monitoring data set to monitor the model performance in the model monitoring processing. The monitoring parameter may include a performance evaluation threshold value for monitoring the model performance in the model monitoring processing.

The communication apparatus 501 may transmit request information to request provision of the monitoring data set to the communication apparatus 502. The communication apparatus 501 may receive the monitoring data set transmitted from the communication apparatus 502 based on the request information.

The communication apparatus 501 may perform the model monitoring processing as follows. Specifically, the communication apparatus 501 derives correct answer data (for example, CSI feedback information) from the monitoring data set (for example, a full CSI-RS) without using the trained model. The communication apparatus 501 acquires inference result data (for example, inferred CSI feedback information) output by the trained model through an input of partial data (for example, a partial CSI-RS) obtained by reducing the monitoring data set.

Then, the communication apparatus 501 compares the correct answer data and the inference result data and thereby evaluates the performance of the trained model. For example, when an error of the inference result data with respect to the correct answer data is within a predetermined threshold value range, the communication apparatus 501 may determine that the inference performance of the model satisfies a criterion. On the other hand, when the error of the inference result data with respect to the correct answer data is out of the predetermined threshold value range, the communication apparatus 501 may determine that the inference performance of the model does not satisfy the criterion.

Note that, when the communication apparatus 501 is the UE 100 and the communication apparatus 502 is the gNB 200, the monitoring data set may include a reference signal transmitted from the gNB 200 to the UE 100. The reference signal may be a CSI-RS or a positioning reference signal (PRS).

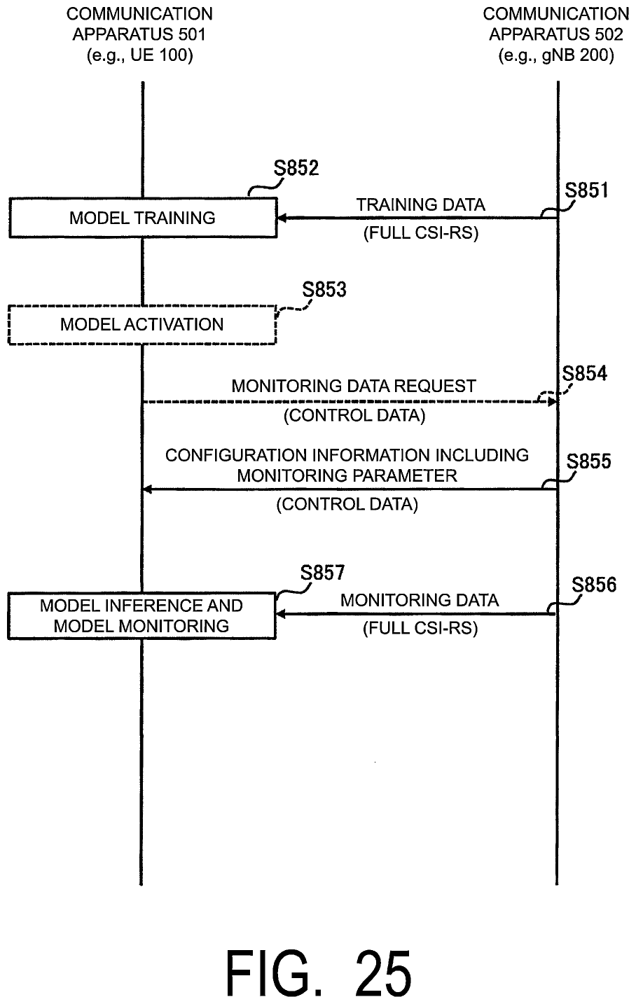

FIG. 25 is a diagram illustrating an example of applying the AI/ML technology to CSI feedback as an example of the second operation pattern relating to model monitoring according to an embodiment.

In step S851, the communication apparatus 502 provides training data (training data set) to the communication apparatus 501. The training data may be a full CSI-RS, for example.

In step S852, the communication apparatus 501 performs the model training using the training data, and thereby generates a trained model.

In step S853, the communication apparatus 501 may activate the model.

In step S854, when the monitoring data set is necessary, the communication apparatus 501 may transmit a request for the data set to the communication apparatus 502 as control data. The request may include a request value of the monitoring parameter configured in step S855.

In step S855, the communication apparatus 502 transmits configuration information including the monitoring parameter to the communication apparatus 501 as control data. The communication apparatus 501 receives the configuration information.

The configuration information includes at least one selected from the group consisting of the following configuration parameters (D1) to (D5).

### (D1) Time Information Indicating Monitoring Time Period

The information indicates at least one selected from the group consisting of a monitoring period, a monitoring timing, and a time period for evaluating the model performance. The information may be a bitmap of a slot (or the like). For example, the communication apparatus 502 transmits a full CSI-RS once (one slot) at a radio frame, and transmits a partial CSI-RS at other timings (other timings). The monitoring time period may be dynamically configured. When the communication apparatus 502 is the gNB, start and/or stop of monitoring data transmission (or the model monitoring processing performed by the communication apparatus 501) may be provided using DCI (or a MAC CE).

### (D2) Resource Information Indicating Monitoring Resources

The information may be information indicating frequency resources in which the monitoring data set is provided, for example, a resource block start position, the number of resource blocks, and the like. The resources for providing the monitoring data set may be configured independently of resources for providing the inference data.

### (D3) Information Indicating Application of Monitoring Data Set

The information indicates one of CSI feedback, beam management, and positioning as the application of the monitoring data set, for example. Here, CSI feedback is configured as the application of the monitoring data set.

### (D4) Information Indicating Use Condition of Monitoring Data Set

The information indicates CSI-RS resources (which may be a plurality of patterns) that the communication apparatus 502 may puncture, for example. The communication apparatus 501 performs (pseudo) puncturing of an indicated pattern and evaluates the performance of the model at the time of the model monitoring.

### (D5) Threshold Related to Performance Evaluation of Model Monitoring

The threshold value is a threshold value indicating an error range between the inference result data and the correct answer data, for example.

In step S856, the communication apparatus 502 provides monitoring data (monitoring data set) to the communication apparatus 501 in the monitoring time period. The monitoring data may be a full CSI-RS, for example.

In step S857, the communication apparatus 501 performs the model inference and the model monitoring. Here, the communication apparatus 501 derives the correct answer data (for example, the CSI feedback information) from the monitoring data set without using the trained model. The communication apparatus 501 acquires the inference result data (for example, the inferred CSI feedback information) output by the trained model through an input of partial data (for example, a partial CSI-RS) obtained by reducing the monitoring data set. Then, the communication apparatus 501 compares the correct answer data and the inference result data and thereby evaluates the performance of the trained model.

Here, an example has been described in which the communication apparatus 501 is the UE 100, the communication apparatus 502 is the gNB 200, and the AI/ML technology is applied to CSI feedback. However, the communication apparatus 501 may be the gNB 200, the communication apparatus 502 may be the UE 100, and the AI/ML technology may be applied to SRS transmission. In this case, the gNB 200 performs the model inference and the model monitoring. For example, the gNB 200 configures a timing (that is, a monitoring time period) of transmission of a full SRS for the communication apparatus 501, for example. In this case, the gNB 200 may transmit at least one selected from the group consisting of (D1) to (D3) described above to the UE 100. The UE 100 transmits a full SRS at the timing, and transmits a punctured SRS at other timings. Here, the UE 100 may periodically transmit the full SRS as with a configured grant. The UE 100 may transmit the full SRS in one shot using DCI (or a MAC CE) as with PDCCH order. The gNB 200 may notify the UE 100 of start and/or stop of transmission of the full SRS using DCI (or a MAC CE), and thereby cause the UE 100 to perform transmission of the full SRS.

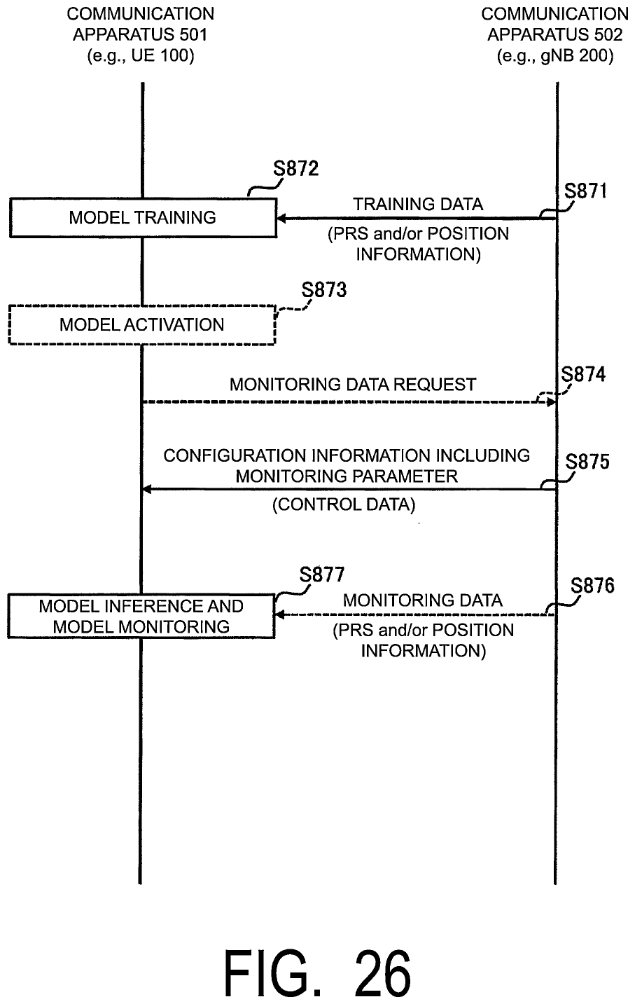

FIG. 26 is a diagram illustrating an example of applying the AI/ML technology to positioning (specifically, generation of position information of the communication apparatus 501) as another example of the second operation pattern relating to model monitoring according to an embodiment.

In step S871, the communication apparatus 502 provides training data (training data set) to the communication apparatus 501. The training data may be a full PRS, for example. The communication apparatus 501 may derive position information from the full PRS, and using the full PRS and the position information as the training data, the communication apparatus 501 may generate a trained model for deriving the position information from the PRS (step S872). The training data may be a general reference signal or a PRS. When the communication apparatus 501 includes the GNSS reception device, using a reception state (a so-called RF fingerprint) of a general reference signal or a PRS and GNSS position information as the training data, the communication apparatus 501 may generate a trained model for deriving the position information from the RF fingerprint (step S872). Here, when the communication apparatus 501 does not include the GNSS reception device, the communication apparatus 501 may use the position information provided from the location server, instead of the GNSS position information.

In step S873, the communication apparatus 501 may activate the model.

In step S874, when the monitoring data set is necessary, the communication apparatus 501 may transmit a request for the data set to the communication apparatus 502 as control data. The request may include a request value of the monitoring parameter configured in step S875.

In step S875, the communication apparatus 502 transmits configuration information including the monitoring parameter to the communication apparatus 501 as control data. The communication apparatus 501 receives the configuration information. The configuration information may include a parameter for configuring a data source (for example, the GNSS reception device, the location server, or the like) of the correct answer data at the time of the model monitoring, in addition to at least one selected from the group consisting of the configuration parameters (D1) to (D5) described above.

In step S876, the communication apparatus 501 provides the training data (training data set) to the communication apparatus 501 in the monitoring time period. The training data may be the full PRS or the position information provided by the location server, for example.

In step S877, the communication apparatus 501 performs the model inference and the model monitoring. As a first example of the model monitoring, when the position information (GNSS position information) from the GNSS reception device of the communication apparatus 501 is used as the correct answer data, the communication apparatus 501 performs the model inference using the PRS reception state as input data, compares an error between the inference result data and the GNSS position information with a threshold value, and thereby evaluates the performance of the model.

As a second example of the model monitoring, when the position information (server-provided position information) provided by the location server is used as the correct answer data, the communication apparatus 501 performs the model inference using the PRS reception state as input data, compares an error between the inference result data and the server-provided position information with a threshold value, and thereby evaluates the performance of the model. Here, the communication apparatus 501 may notify the location server of the PRS reception state, and thereby acquire the server-provided position information from the location server.

As a third example of the model monitoring, when the position information derived from the full PRS is used as the correct answer data, the communication apparatus 501 derives the position information as the correct answer data from the full PRS without using the trained model. The communication apparatus 501 acquires the inference result data (that is, inferred position information) output by the trained model through an input of a partial PRS obtained by reducing the full PRS. Then, the communication apparatus 501 compares the correct answer data and the inference result data and thereby evaluates the performance of the trained model.

### CSI Feedback and Beam Management to Which AI/ML Technology is Applied

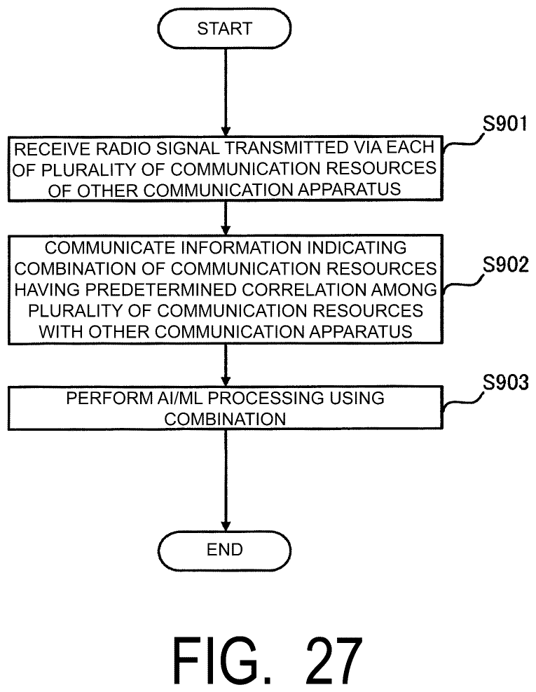

FIG. 27 is a diagram illustrating CSI feedback and beam management to which the AI/ML technology is applied according to an embodiment.

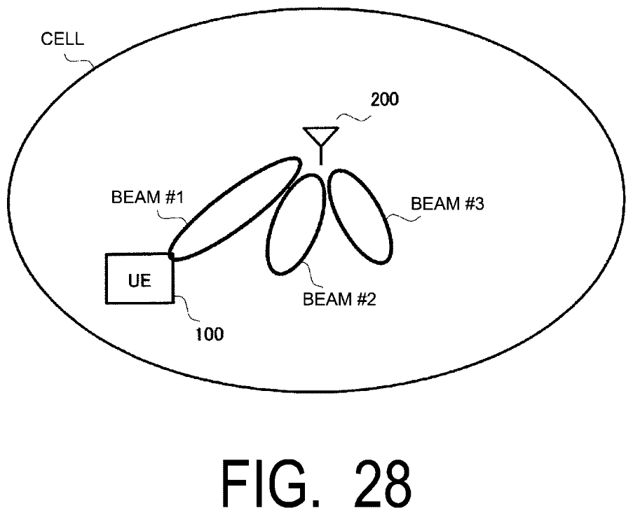

In step S901, the communication apparatus 501 receives a radio signal transmitted via each of a plurality of communication resources of the communication apparatus 502. When CSI feedback is assumed, the plurality of communication resources are a plurality of antenna ports included in the communication apparatus 502 (see FIG. 9). When beam management is assumed, the plurality of communication resources are a plurality of beams formed by the communication apparatus 502 (for example, the gNB 200) (see FIG. 28).

In step S902, the communication apparatus 501 communicates (that is, transmits and/or receives) information indicating a combination of communication resources having a predetermined correlation among the plurality of communication resources with the communication apparatus 502. When CSI feedback is assumed, the information indicating the combination includes identification information about the antenna ports constituting the combination. When beam management is assumed, the information indicating the combination includes identification information about the beams constituting the combination.

In step S903, the communication apparatus 501 performs the AI/ML processing (machine learning processing) using the combination.

When the communication apparatus 501 communicates the information indicating the combination of the communication resources having the predetermined correlation with the communication apparatus 502 as described above, the AI/ML processing (machine learning processing) can be efficiently performed using the combination. The combination of the communication resources having the predetermined correlation may be hereinafter referred to as a combination of antenna ports having a high correlation or a combination of beams having a high correlation.

In step S902, the communication apparatus 501 may receive a notification including the information indicating the combination from the communication apparatus 502 as control data. In step S902, the communication apparatus 501 may transmit a notification including the information indicating the combination and/or information related to the communication resource that can stop transmission of the radio signal to the communication apparatus 502.

The communication apparatus 501 may identify the combination to be communicated, and acquire the trained model, based on the identified combination and the radio signal received from the communication apparatus 502. The trained model may be a model to derive the inference result data for another communication resource constituting the combination, based on reception state data of the radio signal of one communication resource constituting the combination. The communication apparatus 501 may derive the inference result data for the other communication resource, based on the reception state data of the radio signal of the one communication resource.

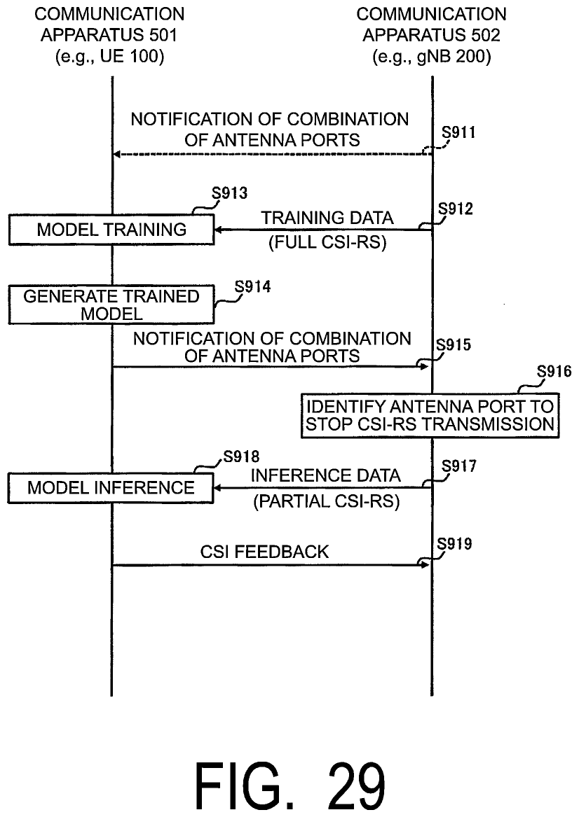

FIG. 29 is a diagram illustrating a specific example of CSI feedback to which the AI/ML technology is applied according to an embodiment.

In step S911, the communication apparatus 502 may transmit a notification including information indicating a combination of antenna ports having a high correlation to the communication apparatus 501 as control data. The communication apparatus 501 receives the notification. The combination may be a combination of antenna ports to be subjected to the model training by the communication apparatus 501.

In step S912, the communication apparatus 502 transmits a full CSI-RS from a plurality of antenna ports. The communication apparatus 501 receives the full CSI-RS. When the notification of step S911 is absent, the communication apparatus 501 may identify the combination of the antenna ports having a high correlation. For example, the communication apparatus 501 performs the model training using the CSI-RS (full CSI-RS) transmitted from two antenna ports and generates a trained model (step S913). Then, when a CSI-RS (a partial CSI-RS) of one antenna port obtained by reducing (puncturing) the full CSI-RS is input to the trained model as input data and the inference result output from the trained model is within a certain error range with respect to the correct answer data, the communication apparatus 501 may determine that the two antenna ports have a high correlation.

In step S914, the communication apparatus 501 generates a trained model using the combination of the antenna ports having a high correlation. For example, the communication apparatus 501 generates the trained model for estimating the CSI of antenna port #2 from the CSI-RS reception result of antenna port #1, using the combination of antenna ports #1 and #2 having a high correlation.

In step S915, the communication apparatus 501 transmits a notification indicating that the model training has been completed or a notification including the information of the antenna ports having a high correlation to the communication apparatus 502 as control data. When generation of the trained model has been completed in step S914 or testing of the trained model has been completed, the communication apparatus 501 may perform a notification of step S915. The notification of step S915 may include at least one selected from the group consisting of information indicating the combination of the antenna ports having a high correlation (for example, antenna port numbers of the antenna ports having a high correlation), information indicating the combination of the antenna ports for which generation of the trained model has been completed, information indicating the antenna ports that can stop transmission of the CSI-RS (for example, antenna port numbers), and information indicating the antenna ports to continuously transmit the CSI-RS.

In step S916, the communication apparatus 502 identifies the antenna ports to stop transmission of the CSI-RS, based on the notification of step S915.

In step S917, due to the stop of transmission of a part of the CSI-RS, the communication apparatus 502 transmits a partial CSI-RS. The communication apparatus 501 receives the partial CSI-RS.

In step S918, the communication apparatus 501 derives CSI based on the partial CSI-RS as the inference result data through the model inference using the trained model generated in step S914.

In step S919, the communication apparatus 501 transmits CSI feedback information being the inference result data to the communication apparatus 502. The communication apparatus 502 receives the CSI feedback information.

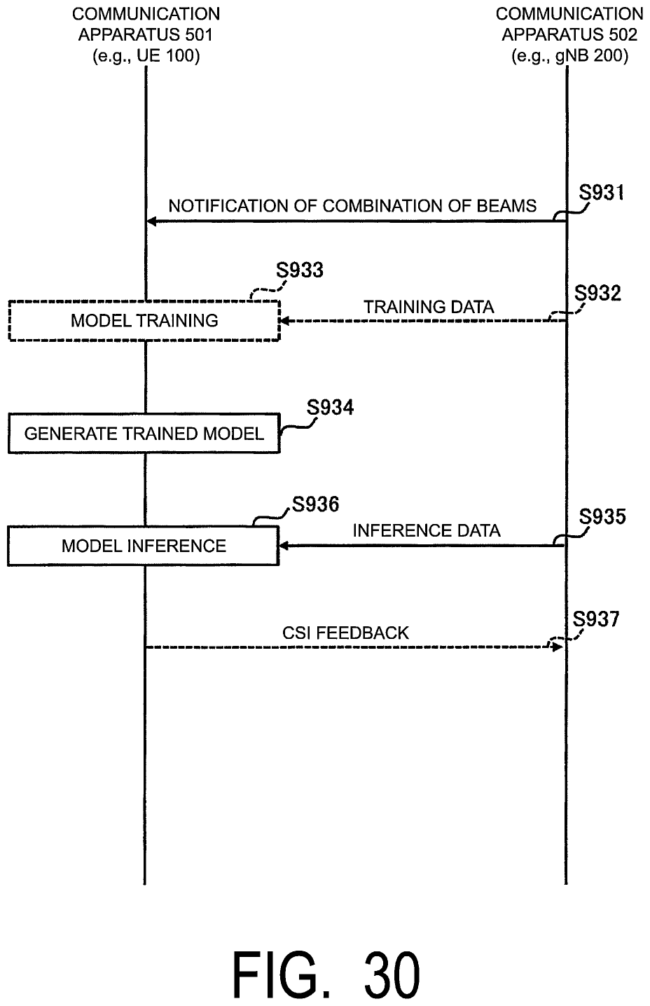

FIG. 30 is a diagram illustrating a specific example of beam management to which the AI/ML technology is applied according to an embodiment. Here, as illustrated in FIG. 28, the communication apparatus 502 (the gNB 200 in the illustrated example) forms a plurality of beams (for example, beams #1 to #3). The beam management may be beam management for SSB-based beamforming. Such beam management includes SSB selection in the RRC idle state and beam monitoring and recovery in the RRC connected state, for example. The beam management may be beam management for CSI-RS-based beamforming (precoding). Such beam management includes management for beamforming of the PDSCH in the RRC connected state, for example.

In the present specific example, the communication apparatus 501 estimates another beam (for example, beam #2) by measuring one beam (for example, beam #1), specifically, estimates a measurement result of the other beam, using the AI/ML technology. To realize such estimation, beam control of beam #1 and beam #2 needs to be synchronized. This is because the estimation as described above cannot be performed when the beams have a low correlation, for example, when precoding is different for each slot.

As illustrated in FIG. 30, in step S931, the communication apparatus 502 transmits a notification including information indicating a combination of two or more beams to be subjected to synchronized control to the communication apparatus 501. The notification may be a notification indicating correspondence between a beam to be used as inference data and a beam to be inferred. The communication apparatus 501 receives the notification. The notification includes at least one selected from the group consisting of the following pieces of information (E1) to (E3).

### (E1) Association Information of Beam Identifiers

It concerns a set of two or more beam identifiers (beam indexes). For example, the communication apparatus 502 notifies the communication apparatus 501 that beam #1 and beam #2 are associated (that is, synchronized). The communication apparatus 502 may notify the communication apparatus 501 that beam #1 and beam #2 have a high correlation in the current position and propagation environment of the communication apparatus 501. It may be a notification that estimation can be performed between beam #1 and beam #2.

### (E2) Timing Information for Synchronized Control

For example, it is association information with respect to time, such as beam #1 and beam #2 in slot #1 and beam #1 and beam #3 in slot #2. One piece of time information may be individually associated with one set of beam identifiers. One piece of time information may be commonly associated with two or more sets of beam identifiers.

### (E3) Precoding (Weight) Information of Beams to be Synchronized

For example, the communication apparatus 501 infers the measurement result in a case of reception with beam #2, using the precoding (weight) information of beam #2 and measurement information of beam #1.

In step S932, the communication apparatus 502 forms a plurality of beams and transmits a radio signal (for example, an SSB, a PDSCH, or the like). The communication apparatus 501 receives and measures each beam.

In step S933, the communication apparatus 501 performs the model training, based on the notification of step S931. For example, the communication apparatus 501 performs the model training for inferring the measurement result of another beam from the measurement information (measurement result) of one beam.

In step S934, the communication apparatus 501 generates a trained model using a combination of beams having a high correlation. For example, the communication apparatus 501 generates the trained model for estimating the measurement result of beam #2 from the measurement result of beam #1, using a combination of beams #1 and #2 having a high correlation.

In step S935, the communication apparatus 502 forms a plurality of beams and transmits a radio signal (for example, an SSB, a PDSCH, or the like). The communication apparatus 501 receives and measures the beams.

In step S936, the communication apparatus 501 performs beam measurement, and infers other beams. The communication apparatus 501 may use the inference result to estimate that other beams have higher quality than the current beam (precoding), for example.

In step S937, the communication apparatus 501 may feed the inference result back to the communication apparatus 502 as CSI, for example. Here, the communication apparatus 501 may transmit CSI feedback information to the communication apparatus 502 together with information indicating that it is the inferred CSI.

### Other Embodiments

The above-described embodiment has mainly described the communication between the UE 100 and the gNB 200, but the operations according to the above-described embodiment may be applied to communication between the gNB 200 and the AMF 300A (i.e., communication between the base station and the core network). The above-described control data may be transmitted from the gNB 200 to the AMF 300A over the NG interface. The above-described control data may be transmitted from the AMF 300A to the gNB 200 over the NG interface. The AMF 300A and the gNB 200 may exchange a request to perform the federated learning and/or a training result of the federated learning with each other. The above-described operation scenario operations may be applied to communication between the gNB 200 and another gNB 200 (i.e., inter-base station communication). The above-described control data may be transmitted from the gNB 200 to the other gNB 200 over the Xn interface. The gNB 200 and the other gNB 200 may exchange a request to perform the federated learning and/or a training result of the federated learning with each other. The above-described operations may be applied to communication between the UE 100 and another UE 100 (i.e., inter-user equipment communication). The above-described control data may be transmitted from the UE 100 to the other UE 100 over the sidelink. The UE 100 and the other UE 100 may exchange a request to perform the federated learning and/or a training result of the federated learning with each other.

The operation flows described above can be separately and independently implemented, and also be implemented in combination of two or more of the operation flows. For example, some of the steps in one operation flow may be applied to another operation flow. Some of the steps in one operation flow may be replaced with some of the steps in another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node. The user equipment (terminal apparatus) may be a relay node such as an IAB node or a Mobile Termination (MT) of the IAB node.

A program causing a computer to execute each piece of the processing performed by the communication apparatus (e.g., UE 100 or gNB 200) may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms such as “include” and “comprise” do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note

Features relating to the embodiments described above are described below as supplements.

### Supplementary Note 1

A communication method for applying a machine learning technology to wireless communication between a user equipment and a base station in a mobile communication system, the communication method including:
transmitting, by one communication apparatus among a user equipment and a base station, a notification indicating at least one selected from the group consisting of including an untrained model, including a model in training, and including a trained model on which testing has been completed to the other communication apparatus among the user equipment and the base station; and
receiving, by the one communication apparatus, a response corresponding to the notification from the other communication apparatus.

### Supplementary Note 2

The communication method according to supplementary note 1, wherein
the transmitting is transmitting the notification indicating the including of the untrained model, and
the receiving includes receiving, as the response, a data set and/or a configuration parameter to be used for model training.

### Supplementary Note 3

The communication method according to supplementary note 1, wherein
the transmitting is transmitting the notification indicating the including of the model in training, and
the receiving includes receiving, as the response, a data set to continue model training.

### Supplementary Note 4

The communication method according to supplementary note 1, wherein
the transmitting is transmitting the notification indicating the including of the trained model on which the testing has been completed, and
the receiving includes receiving, as the response, information to start use of the trained model on which the testing has been completed.

### Supplementary Note 5

The communication method according to any one of supplementary notes 1 to 4, wherein the notification includes an index of the model and/or identification information configured to identify a type or an application of the model.

### Supplementary Note 6

A communication method for applying a machine learning technology to wireless communication between a user equipment and a base station in a mobile communication system, the communication method including:
performing, by one communication apparatus among a user equipment and a base station, inference processing using a trained model obtained by training a model;
determining, by the one communication apparatus, necessity of retraining the model by monitoring a performance of the trained model; and
transmitting, by the one communication apparatus, a notification indicating the necessity of the retraining to the other communication apparatus among the user equipment and the base station, in response to determining that the retraining is necessary.

### Supplementary Note 7

The communication method according to supplementary note 6, further including:
receiving, by the one communication apparatus, configuration information including a parameter related to the monitoring of the performance from the other communication apparatus; and
performing, by the one communication apparatus, monitoring processing of monitoring the performance of the trained model, using the parameter included in the configuration information.

### Supplementary Note 8

The communication method according to supplementary note 6 or 7, wherein the notification includes information to request provision of training data to be used for the retraining.

### Supplementary Note 9

The communication method according to supplementary note 8, wherein the notification includes identification information configured to identify a type of the training data.

### Supplementary Note 10

The communication method according to any one of supplementary notes 6 to 9, wherein the notification includes an index of the model and/or identification information configured to identify a type or an application of the model.

### Supplementary Note 11

A communication method for applying a machine learning technology to wireless communication between a user equipment and a base station in a mobile communication system, the communication method including:
receiving, by one communication apparatus among a user equipment and a base station, configuration information including a monitoring parameter configured to monitor a performance of a trained model from the other communication apparatus among the user equipment and the base station; and
performing, by the one communication apparatus, the monitoring processing using a monitoring data set, based on the configuration information.

### Supplementary Note 12

The communication method according to supplementary note 11, wherein
the monitoring parameter includes time information indicating a time during which the monitoring data set is provided from the other communication apparatus, and
the performing of the monitoring processing includes receiving the monitoring data set from the other communication apparatus and performing the monitoring processing during the time indicated by the time information.

### Supplementary Note 13

The communication method according to supplementary note 11 or 12, further including transmitting, by the one communication apparatus, request information configured to request provision of the monitoring data set to the other communication apparatus,
wherein the performing of the monitoring processing includes receiving the monitoring data set transmitted from the other communication apparatus based on the request information.

### Supplementary Note 14

The communication method according to any one of supplementary notes 11 to 13, wherein the monitoring parameter further includes information indicating a condition of reducing and using the monitoring data set to monitor the performance in the monitoring processing.

### Supplementary Note 15

The communication method according to any one of supplementary notes 11 to 14, wherein the monitoring parameter further includes a performance evaluation threshold value configured to monitor the performance in the monitoring processing.

### Supplementary Note 16

The communication method according to any one of supplementary notes 11 to 15, wherein the monitoring includes:
deriving correct answer data from the monitoring data set without using the trained model;
acquiring inference result data output by the trained model through an input of partial data obtained by reducing the monitoring data set; and
evaluating the performance of the trained model by comparing the correct answer data and the inference result data.

### Supplementary Note 17

The communication method according to any one of supplementary notes 11 to 16, wherein the one communication apparatus is the user equipment and the other communication apparatus is the base station, and
the monitoring data set includes a reference signal transmitted from the base station to the user equipment.

### REFERENCE SIGNS

1: Mobile communication system
100: UE
110: Receiver
120: Transmitter
130: Controller
131: CSI generator
132: Position information generator
140: GNSS reception device
200: gNB
210: Transmitter
220: Receiver
230: Controller
231: CSI generator
240: Backhaul communicator
400: Location server
501: Communication apparatus
502: Communication apparatus
A1: Data collector
A2: Model trainer
A3: Model inferrer
A4: Data processor
A5: Federated trainer

1. A communication method for applying a machine learning technology to wireless communication between a user equipment and a network node in a mobile communication system, the communication method comprising the steps of:
transmitting, by one communication apparatus among a user equipment and a network node, a notification indicating at least one selected from the group consisting of comprising an untrained model, comprising a model in training, and comprising a trained model on which testing has been completed to the other communication apparatus among the user equipment and the network node; and
receiving, by the one communication apparatus, a response corresponding to the notification from the other communication apparatus.

2. The communication method according to claim 1, wherein
the transmitting is transmitting the notification indicating the comprising of the untrained model, and
the receiving comprises receiving, as the response, a data set and/or a configuration parameter to be used for model training.

3. The communication method according to claim 1, wherein
the transmitting is transmitting the notification indicating the comprising of the model in training, and
the receiving comprises receiving, as the response, a data set to continue model training.

4. The communication method according to claim 1, wherein
the transmitting is transmitting the notification indicating the comprising of the trained model on which the testing has been completed, and
the receiving comprises receiving, as the response, information to start use of the trained model on which the testing has been completed.

5. The communication method according to claim 1, wherein the notification comprises an index of the model and/or identification information configured to identify a type or an application of the model.

6. A communication method for applying a machine learning technology to wireless communication between a user equipment and a network node in a mobile communication system, the communication method comprising the steps of:
performing, by one communication apparatus among a user equipment and a network node, inference processing using a trained model obtained by training a model;
determining, by the one communication apparatus, necessity of retraining the model by monitoring a performance of the trained model; and
transmitting, by the one communication apparatus, a notification indicating the necessity of the retraining to the other communication apparatus among the user equipment and the network node, in response to determining that the retraining is necessary.

7. The communication method according to claim 6, further comprising the steps of:
receiving, by the one communication apparatus, configuration information comprising a parameter related to the monitoring of the performance from the other communication apparatus; and
performing, by the one communication apparatus, monitoring processing of monitoring the performance of the trained model, using the parameter comprised in the configuration information.

8. The communication method according to claim 6, wherein the notification comprises information configured to request provision of training data to be used for the retraining.

9. The communication method according to claim 8, wherein the notification comprises identification information configured to identify a type of the training data.

10. The communication method according to claim 6, wherein the notification comprises an index of the model and/or identification information configured to identify a type or an application of the model.

11. A communication method for applying a machine learning technology to wireless communication between a user equipment and a network node in a mobile communication system, the communication method comprising the steps of:
receiving, by one communication apparatus among a user equipment and a network node, configuration information comprising a monitoring parameter configured to monitor a performance of a trained model from the other communication apparatus among the user equipment and the network node; and
performing, by the one communication apparatus, a monitoring processing using a monitoring data set, based on the configuration information.

12. The communication method according to claim 11, wherein
the monitoring parameter comprises time information indicating a time during which the monitoring data set is provided from the other communication apparatus, and
the performing of the monitoring processing comprises receiving the monitoring data set from the other communication apparatus and performing the monitoring processing during the time indicated by the time information.

13. The communication method according to claim 11, further comprising transmitting, by the one communication apparatus, request information configured to request provision of the monitoring data set to the other communication apparatus,
wherein the performing of the monitoring processing comprises receiving the monitoring data set transmitted from the other communication apparatus based on the request information.

14. The communication method according to claim 11, wherein the monitoring parameter further comprises information indicating a condition of reducing and using the monitoring data set to monitor the performance in the monitoring processing.

15. The communication method according to claim 11, wherein the monitoring parameter further comprises a performance evaluation threshold value configured to monitor the performance in the monitoring processing.

16. The communication method according to claim 11, wherein
the monitoring comprises:
deriving correct answer data from the monitoring data set without using the trained model;
acquiring inference result data output by the trained model through an input of partial data obtained by reducing the monitoring data set; and
evaluating the performance of the trained model by comparing the correct answer data and the inference result data.

17. The communication method according to claim 11, wherein
the one communication apparatus is the user equipment and the other communication apparatus is the network node, and
the monitoring data set comprises a reference signal transmitted from the network node to the user equipment.
